(19) United States
(12) Patent Application Publication
(10) Pub. No.: US 2025/0076615 A1
(43) Pub. Date: Mar. 6, 2025

(54) OPTICAL LENS ASSEMBLY, IMAGING APPARATUS AND ELECTRONIC DEVICE

(71) Applicant: LARGAN PRECISION CO., LTD., Taichung City (TW)

(72) Inventors: I-Chieh CHEN, Taichung City (TW); Hsin-Hsuan HUANG, Taichung City (TW); Yu-Han SHIH, Taichung City (TW)

(21) Appl. No.: 18/768,216

(22) Filed: Jul. 10, 2024

(30) Foreign Application Priority Data
Aug. 29, 2023 (TW) 112132457

(51) Int. Cl. G02B 13/00; G02B 1/04; G02B 9/60; H04N 23/55

(52) U.S. Cl. CPC G02B 13/0045; G02B 1/041; G02B 9/60; G02B 13/0065; H04N 23/55

(57) ABSTRACT

An optical lens assembly includes five lens elements, the five lens elements are, in order from an object side to an image side, a first lens element, a second lens element, a third lens element, a fourth lens element and a fifth lens element. Each of the five lens elements has an object-side surface towards the object side and an image-side surface towards the image side. The fourth lens element with positive refractive power has the object-side surface being convex in a paraxial region thereof. The fifth lens element with negative refractive power has the object-side surface being concave in a paraxial region thereof and the image-side surface being concave in a paraxial region thereof.

### RELATED APPLICATIONS

This application claims priority to Taiwan Application Serial Number 112132457, filed Aug. 29, 2023, which is herein incorporated by reference.

### BACKGROUND

### Technical Field

The present disclosure relates to an optical lens assembly and an imaging apparatus. More particularly, the present disclosure relates to an optical lens assembly and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of the electronic devices equipped with optical lens assemblies become wider, and there is a bigger variety of requirements for the optical lens assemblies. In a conventional optical lens assembly, it is hard to balance among image quality, sensitivity, aperture size, volume or field of view, so an optical lens assembly with high imaging quality is provided in the present disclosure to meet the requirements.

### SUMMARY

According to one aspect of the present disclosure, an optical lens assembly includes five lens elements, the five lens elements are, in order from an object side to an image side, a first lens element, a second lens element, a third lens element, a fourth lens element and a fifth lens element. Each of the five lens elements has an object-side surface towards the object side and an image-side surface towards the image side. Preferably, the fourth lens element with positive refractive power has the object-side surface being convex in a paraxial region thereof. Preferably, the fifth lens element with negative refractive power has the object-side surface being concave in a paraxial region thereof and the image-side surface being concave in a paraxial region thereof. When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the first lens element is R1, a curvature radius of the object-side surface of the fourth lens element is R7, a curvature radius of the object-side surface of the fifth lens element is R9, an axial distance between the object-side surface of the first lens element and an image surface is TL, a central thickness of the fourth lens element is CT4, a composite focal length of the fourth lens element and the fifth lens element is f45, a sum of all central thicknesses of the five lens elements of the optical lens assembly is ΣCT, and a sum of all axial distances between adjacent lens elements of the optical lens assembly is ΣAT, the following conditions are preferably satisfied: 2.0<ATmax/ATmin<7.5; −1.50<R7/f45<0.00; 9.60<TL/CT4<18.00; 0.60<ΣCT/ΣAT<1.30; and 0.08<|R9/R1|<45.00.

According to the present disclosure, an imaging apparatus includes the aforementioned optical lens assembly and an image sensor, and the image sensor is disposed on the image surface of the optical lens assembly.

According to the present disclosure, an electronic device includes the aforementioned imaging apparatus.

According to another aspect of the present disclosure, an optical lens assembly includes five lens elements, the five lens elements are, in order from an object side to an image side, a first lens element, a second lens element, a third lens element, a fourth lens element and a fifth lens element. Each of the five lens elements has an object-side surface towards the object side and an image-side surface towards the image side. Preferably, the image-side surface of the first lens element is concave in a paraxial region thereof. Preferably, the object-side surface of the fourth lens element is convex in a paraxial region thereof. Preferably, the object-side surface of the fifth lens element is concave in a paraxial region thereof, the image-side surface of the fifth lens element comprises at least one inflection point. When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the fourth lens element is R7, an axial distance between the object-side surface of the first lens element and an image surface is TL, a focal length of the optical lens assembly is f, a focal length of the third lens element is f3, a focal length of the fourth lens element is f4, a composite focal length of the fourth lens element and the fifth lens element is f45, a central thickness of the first lens element is CT1, a central thickness of the second lens element is CT2, a central thickness of the third lens element is CT3, a central thickness of the fourth lens element is CT4, a central thickness of the fifth lens element is CT5, a maximum among CT1, CT2, CT3, CT4, CT5 is CTmax, and a minimum among CT1, CT2, CT3, CT4, CT5 is CTmin, the following conditions are preferably satisfied: 2.0<ATmax/ATmin<7.5; −1.50<R7/f45<0.00; 9.60<TL/CT4<18.00; 0.03<|f/f3|+|f/f4|<1.60; and 1.40<CTmax/CTmin<2.80.

According to another aspect of the present disclosure, an optical lens assembly includes five lens elements, the five lens elements are, in order from an object side to an image side, a first lens element, a second lens element, a third lens element, a fourth lens element and a fifth lens element. Each of the five lens elements has an object-side surface towards the object side and an image-side surface towards the image side. Preferably, the image-side surface of the first lens element is concave in a paraxial region thereof. Preferably, the object-side surface of the fourth lens element is convex in a paraxial region thereof, the object-side surface of the fourth lens element comprises at least one inflection point. Preferably, the fifth lens element with negative refractive power has the object-side surface being concave in a paraxial region thereof. When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the first lens element is R1, a curvature radius of the image-side surface of the first lens element is R2, a curvature radius of the object-side surface of the fourth lens element is R7, a focal length of the optical lens assembly is f, a composite focal length of the first lens element and the second lens element is f12, a composite focal length of the fourth lens element and the fifth lens element is f45, a sum of all central thicknesses of the five lens elements of the optical lens assembly is ΣCT, and a sum of all axial distances between adjacent lens elements of the optical lens assembly is ΣAT, the following conditions are preferably satisfied: 2.00<ATmax/ATmin<6.20; −1.25<R7/f45<−0.03; 0.60<ΣCT/ΣAT<1.20; 0.60<f/f12<1.10; and 0.30<1R2/R1|<12.00.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an imaging apparatus according to the 1 st embodiment of the present disclosure.

FIG. 2 shows, in order from left to right, spherical aberration curves, astigmatic field curves and a distortion curve of the imaging apparatus according to the 1st embodiment.

FIG. 3 is a schematic view of an imaging apparatus according to the 2nd embodiment of the present disclosure.

FIG. 4 shows, in order from left to right, spherical aberration curves, astigmatic field curves and a distortion curve of the imaging apparatus according to the 2nd embodiment.

FIG. 5 is a schematic view of an imaging apparatus according to the 3rd embodiment of the present disclosure.

FIG. 6 shows, in order from left to right, spherical aberration curves, astigmatic field curves and a distortion curve of the imaging apparatus according to the 3rd embodiment.

FIG. 7 is a schematic view of an imaging apparatus according to the 4th embodiment of the present disclosure.

FIG. 8 shows, in order from left to right, spherical aberration curves, astigmatic field curves and a distortion curve of the imaging apparatus according to the 4th embodiment.

FIG. 9 is a schematic view of an imaging apparatus according to the 5th embodiment of the present disclosure.

FIG. 10 shows, in order from left to right, spherical aberration curves, astigmatic field curves and a distortion curve of the imaging apparatus according to the 5th embodiment.

FIG. 11 is a schematic view of an imaging apparatus according to the 6th embodiment of the present disclosure.

FIG. 12 shows, in order from left to right, spherical aberration curves, astigmatic field curves and a distortion curve of the imaging apparatus according to the 6th embodiment.

FIG. 13 is a schematic view of an imaging apparatus according to the 7th embodiment of the present disclosure.

FIG. 14 shows, in order from left to right, spherical aberration curves, astigmatic field curves and a distortion curve of the imaging apparatus according to the 7th embodiment.

FIG. 15 is a schematic view of an imaging apparatus according to the 8th embodiment of the present disclosure.

FIG. 16 shows, in order from left to right, spherical aberration curves, astigmatic field curves and a distortion curve of the imaging apparatus according to the 8th embodiment.

FIG. 17 is a schematic view of an imaging apparatus according to the 9th embodiment of the present disclosure.

FIG. 18 shows, in order from left to right, spherical aberration curves, astigmatic field curves and a distortion curve of the imaging apparatus according to the 9th embodiment.

FIG. 19 is a schematic view of an imaging apparatus according to the 10th embodiment of the present disclosure.

FIG. 20 shows, in order from left to right, spherical aberration curves, astigmatic field curves and a distortion curve of the imaging apparatus according to the 10th embodiment.

FIG. 21 is a schematic view of inflection points and critical points of each lens element in the 1st embodiment.

FIG. 22 is a schematic view of part of parameters of the 1st embodiment.

FIG. 23 is a three-dimensional schematic view of an imaging apparatus according to the 11th embodiment of the present disclosure.

FIG. 24A is a schematic view of one side of an electronic device according to the 12th embodiment of the present disclosure.

FIG. 24B is a schematic view of another side of the electronic device of FIG. 24A.

FIG. 24C is a system schematic view of the electronic device of FIG. 24A.

FIG. 25 is a schematic view of one side of an electronic device according to the 13th embodiment of the present disclosure.

FIG. 26 is a schematic view of one side of an electronic device according to the 14th embodiment of the present disclosure.

FIG. 27A is a schematic view of one side of an electronic device according to the 15th embodiment of the present disclosure.

FIG. 27B is a schematic view of another side of the electronic device of FIG. 27A.

FIG. 28 is a three-dimensional schematic view of an electronic device according to the 16th embodiment of the present disclosure.

FIG. 29A is a schematic view of an arrangement of a light path folding element in the optical lens assembly of the present disclosure.

FIG. 29B is a schematic view of another arrangement of the light path folding element in the optical lens assembly of the present disclosure.

FIG. 29C is a schematic view of an arrangement of two light path folding elements in the optical lens assembly of the present disclosure.

### DETAILED DESCRIPTION

According to the present disclosure, an optical lens assembly includes five lens elements. The five lens elements are, in order from an object side to an image side, a first lens element, a second lens element, a third lens element, a fourth lens element and a fifth lens element. Each of the five lens elements has an object-side surface towards the object side and an image-side surface towards the image side.

The first lens element can have positive refractive power, which is favorable for light convergence to compress the volume. The object-side surface of the first lens element can be convex in a paraxial region thereof, which can adjust the refractive power of the first lens element. The image-side surface of the first lens element can be concave in a paraxial region thereof, which can balance aberrations such as spherical aberration, comatic aberration, etc. caused by compressing the volume.

The fourth lens element can have positive refractive power, which is favorable for light convergence and effectively controlling the direction of light path. The object-side surface of the fourth lens element is convex in a paraxial region thereof, which can correct astigmatism and chromatic aberration of magnification, and improve imaging quality.

The fifth lens element can have negative refractive power, which can effectively control the back focal length of the optical lens assembly to prevent the total length of the optical lens assembly from being too long. The object-side surface of the fifth lens element is concave in a paraxial region thereof, which is favorable for reducing the distortion of the optical lens assembly and improving the curvature of imaging surface to correct imaging quality. The image-side surface of the fifth lens element can be concave in a paraxial region thereof, which is favorable for reducing the field curvature and compressing the back focal length. Therefore, the optical lens assembly is able to achieve higher standards of specifications with great imaging quality.

The object-side surface of the fourth lens element can include at least one inflection point, which is favorable for adjusting the passing direction of light, and obtaining a balance between compressing the volume and enlarging an image surface. The object-side surface of the fourth lens element can include at least one critical point, which provides sufficient changes at an off-axis region of the object-side surface of the fourth lens element, and is favorable for correcting the field curvature.

The image-side surface of the fourth lens element can include at least one inflection point, which can adjust the peripheral surface shape of the fourth lens element, and is favorable for correcting astigmatism and distortion to enhance the illumination of image. The image-side surface of the fourth lens element can include at least one critical point, which can increase flexibility of designing the shape of the fourth lens element, and is favorable for correcting astigmatism of the peripheral image.

The object-side surface of the fifth lens element can include at least one inflection point, which can control the surface shape change at the peripheral region of the object-side surface of the fifth lens element, and is favorable for reducing the difference between the optical path lengths of the optical lens assembly and enhancing imaging quality.

The image-side surface of the fifth lens element can include at least one inflection point, which can control the incident angle of light entering the image surface to correct and compensate the distortion problem of image. The image-side surface of the fifth lens element can include at least one critical point, which can adjust the light angle at the peripheral region to prevent the incident angle being too large and resulting in poor light convergence at the peripheral region, and simultaneously maintain the peripheral illumination of image.

When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, and a minimum among T12, T23, T34, T45 is ATmin, the following condition is satisfied: 2.0<ATmax/ATmin<7.5. Therefore, the distances between lens elements of the optical lens assembly can be adjusted, which is favorable for balancing the space arrangement of the lens elements to reduce sensitivity of the optical lens assembly. Moreover, the following condition can be satisfied: 2.00<ATmax/ATmin<6.20. Moreover, the following condition can be satisfied: 2.5<ATmax/ATmin<6.0. Moreover, the following condition can be satisfied: 3.34≤ATmax/ATmin≤4.36.

When a curvature radius of the object-side surface of the fourth lens element is R7, and a composite focal length of the fourth lens element and the fifth lens element is f45, the following condition is satisfied: −1.50<R7/f45<0.00. Therefore, the back focal length of the optical lens assembly is balanced by the surface shape of the object-side surface of the fourth lens element, which is favorable for reducing the back focal length. Moreover, the following condition can be satisfied: −1.25<R7/f45<−0.03. Moreover, the following condition can be satisfied: −1.00<R7/f45<−0.10. Moreover, the following condition can be satisfied: −0.32≤R7/f45≤−0.15.

When an axial distance between the object-side surface of the first lens element and the image surface is TL, and a central thickness of the fourth lens element is CT4, the following condition is satisfied: 9.60<TL/CT4<18.00. Therefore, through adjusting the ratio relationship between the total length of the optical lens assembly and the central thickness of the fourth lens element, the light path refraction angle and the total length of the optical lens assembly can be balanced. Moreover, the following condition can be satisfied: 10.00<TL/CT4<15.50. Moreover, the following condition can be satisfied: 10.79≤TL/CT4≤13.57.

When a sum of all central thicknesses of the five lens elements of the optical lens assembly is ΣCT, and a sum of all axial distances between adjacent lens elements of the optical lens assembly is ΣAT, the following condition is satisfied: 0.60<ΣCT/ΣAT<1.30. Therefore, the arrangement of lens elements in the space of the optical lens assembly can be adjusted, which is favorable for controlling the total length thereof. Moreover, the following condition can be satisfied: 0.60<ΣCT/ΣAT<1.20. Moreover, the following condition can be satisfied: 0.70<ΣCT/ΣAT<1.10. Moreover, the following condition can be satisfied: 0.82≤ΣCT/ΣAT≤1.20.

When a curvature radius of the object-side surface of the first lens element is R1, and a curvature radius of the object-side surface of the fifth lens element is R9, the following condition is satisfied: 0.08<|R9/R1|<45.00. Therefore, the controlling ability of light path of the lens elements can be enhanced, and spherical aberration and the field curvature of the optical lens assembly can be balanced to enhance imaging quality. Moreover, the following condition can be satisfied: 0.10<|R9/R1|<25.00. Moreover, the following condition can be satisfied: 1.00<|R9/R1|<15.00. Moreover, the following condition can be satisfied: 1.49≤|R9/R1≤11.73.

When a focal length of the optical lens assembly is f, a focal length of the third lens element is f3, and a focal length of the fourth lens element is f4, the following condition is satisfied: 0.03<|f/f3|+|f/f4|<1.60. Therefore, it can ensure that the third lens element and the fourth lens element have a certain refractive power, which is favorable for adjusting the light path, and obtaining a balance between the imaging quality and the volume of the optical lens assembly. Moreover, the following condition can be satisfied: 0.45<|f/f3|+|f/f4|<1.40. Moreover, the following condition can be satisfied: 0.57≤|f/f3|+|f/f4|≤1.28.

When a central thickness of the first lens element is CT1, a central thickness of the second lens element is CT2, a central thickness of the third lens element is CT3, the central thickness of the fourth lens element is CT4, a central thickness of the fifth lens element is CT5, a maximum among CT1, CT2, CT3, CT4, CT5 is CTmax, and a minimum among CT1, CT2, CT3, CT4, CT5 is CTmin, the following condition is satisfied: 1.40<CTmax/CTmin<2.80. Therefore, the space of the optical lens assembly can be effectively compressed, and the requirement of compactness can be achieved. Moreover, the following condition can be satisfied: 1.45<CTmax/CTmin<2.65. Moreover, the following condition can be satisfied: 1.44≤CTmax/CTmin≤2.54.

When the focal length of the optical lens assembly is f, and a composite focal length of the first lens element and the second lens element is f12, the following condition is satisfied: 0.60<f/f12<1.10. Therefore, the light converging ability of the front lens elements of the optical lens assembly can be improved, which is favorable for reducing the total length of the optical lens assembly and simultaneously correcting aberrations, which improves imaging quality. Moreover, the following condition can be satisfied: 0.70<f/f12<1.05. Moreover, the following condition can be satisfied: 0.77≤f/f12≤1.00.

When the curvature radius of the object-side surface of the first lens element is R1, and a curvature radius of the image-side surface of the first lens element is R2, the following condition is satisfied: 0.30<|R2/R1|<12.00. Therefore, it is favorable for adjusting the surface shape of the first lens element to compress the volume, and simultaneously reducing the generation of spherical aberration. Moreover, the following condition can be satisfied: 0.60<|R2/R1|<10.00. Moreover, the following condition can be satisfied: 2.01≤|R2/R1≤2.54.

When the axial distance between the object-side surface of the first lens element and the image surface is TL, and a maximum image height of the optical lens assembly is ImgH, the following condition is satisfied: 0.90<TL/ImgH<1.28. Therefore, it is favorable for obtaining a balance between compressing the total length and enlarging the image surface. Moreover, the following condition can be satisfied: 0.95<TL/ImgH<1.25.

When the curvature radius of the image-side surface of the first lens element is R2, and an axial distance between the object-side surface of the first lens element and the image-side surface of the fifth lens element is TD, the following condition is satisfied: 0.2<R2/TD<1.5. Therefore, the surface shape of the image-side surface of the first lens element is balanced by the length of lens assembly, and aberrations can be simultaneously corrected to enhance the imaging quality. Moreover, the following condition can be satisfied: 0.5<R2/TD<1.2.

When the focal length of the optical lens assembly is f, the curvature radius of the image-side surface of the first lens element is R2, and a curvature radius of the image-side surface of the second lens element is R4, the following condition is satisfied: 0.30<|f/R2|−|f/R4|<5.00. Therefore, the surface shapes of the first lens element and the second lens element can be effectively balanced to mutually balance central spherical aberration, and the imaging quality is improved. Moreover, the following condition can be satisfied: 0.50<|f/R2|−|f/R4|<3.70.

When a focal length of the first lens element is f1, and a focal length of the fifth lens element is f5, the following condition is satisfied: −2.50<f1/f5<−1.00. Therefore, the refractive power at the front end and the rare end of the optical lens assembly is controlled, which is favorable for enhancing the balance of the optical lens assembly, and simultaneously reducing the eccentric sensitivity. Moreover, the following condition can be satisfied: −1.60<f1/f5<−1.10.

According to the optical lens assembly of the present disclosure, at least two of the five lens elements can be made of plastic material. Therefore, through the aspherical design, the sensitivity of manufacturing can be reduced and the manufacturing cost can be simultaneously decreased.

According to the optical lens assembly of the present disclosure, there can be an air gap on an optical axis between each of adjacent lens elements of the five lens elements. Therefore, it is favorable for reducing the limitations of design, and helps to harmonize the light path to achieve the specification targets.

When an Abbe number of the first lens element is V1, an Abbe number of the second lens element is V2, an Abbe number of the third lens element is V3, an Abbe number of the fourth lens element is V4, an Abbe number of the fifth lens element is V5, and a minimum among V1, V2, V3, V4, V5 is Vmin, the following condition is satisfied: 10.0<Vmin<22.0. Therefore, the material arrangement of lens elements can be adjusted and chromatic aberration generated by the optical lens assembly can be corrected, which is favorable for enhancing imaging quality. Moreover, the following condition can be satisfied: 12.0<Vmin<20.5.

When the axial distance between the third lens element and the fourth lens element is T34, and the central thickness of the second lens element is CT2, the following condition is satisfied: 0.8<T34/CT2<4.0. Therefore, the ratio between the distance between the third lens element and the fourth lens element and the central thickness of the second lens element can be controlled, which is favorable for reducing the manufacturing tolerances. Moreover, the following condition can be satisfied: 1.0<T34/CT2<3.0.

When the Abbe number of the first lens element is V1, and the Abbe number of the second lens element is V2, the following condition is satisfied: 2.50<V1/V2<4.00. Therefore, the light path of the optical lens assembly can be adjusted, and the converging ability between different wavelengths of light can be balanced and chromatic aberration can be corrected. Moreover, the following condition can be satisfied: 2.75<V1/V2<4.00.

When an f-number of the optical lens assembly is Fno, the following condition is satisfied: 1.80<Fno<2.65. Therefore, the size of aperture stop can be controlled, which is favorable for obtaining a balance between the volume and the amount of entering light. Moreover, the following condition can be satisfied: 2.10<Fno<2.55.

When an incident angle between a chief ray in a maximum field of view of the optical lens assembly and the image surface is CRA, the following condition is satisfied: 0.70<tan(CRA)<1.15. Therefore, the incident angle of the image surface can be controlled, which is favorable for reducing the total length and enhancing the size of image. Moreover, the following condition can be satisfied: 0.73<tan(CRA)<1.00.

When the central thickness of the third lens element is CT3, and a distance in parallel with the optical axis between a maximum effective radius position of the object-side surface of the third lens element and a maximum effective radius position of the image-side surface of the third lens element is ET3, the following condition is satisfied: 0.83<CT3/ET3<2.50. Therefore, the ratio between the central thickness of the third lens element and the peripheral thickness of the third lens element can be adjusted, and sufficient peripheral thickness is maintained to make the peripheral light path suitably folds, which is favorable for compressing the volume of the optical lens assembly. Moreover, the following condition can be satisfied: 1.00<CT3/ET3<2.20.

When a maximum effective radius of the object-side surface of the second lens element is Y2R1, and a maximum effective radius of the object-side surface of the fifth lens element is Y5R1, the following condition is satisfied: 2.70<Y5R1/Y2R1<4.70. Therefore, the optical effective radius heights of the second lens element and the fifth lens element can be balanced, which is favorable for enlarging the field of view and compressing the volume. Moreover, the following condition can be satisfied: 3.00<Y5R1/Y2R1<4.50.

When the axial distance between the object-side surface of the first lens element and the image-side surface of the fifth lens element is TD, and an entrance pupil diameter of the optical lens assembly is EPD, the following condition is satisfied: 1.70<TD/EPD<2.60. Therefore, the volume of lens assembly can assist on balancing the overall field of view and the amount of entering light of the optical lens assembly. Moreover, the following condition can be satisfied: 2.00<TD/EPD<2.50.

When half of the maximum field of view of the optical lens assembly is HFOV, the following condition is satisfied: 0.83<tan(HFOV)<1.30. Therefore, the optical lens assembly can have sufficient area for imaging to meet the requirement of field of view of the applied apparatus, and aberrations such as distortion caused by oversized field of view are prevented. Moreover, the following condition can be satisfied: 0.83<tan(HFOV)<1.20.

When the axial distance between the object-side surface of the first lens element and the image surface is TL, and the focal length of the fifth lens element is f5, the following condition is satisfied: −1.80<TL/f5<−0.90. Therefore, the refractive power of the fifth lens element can be adjusted, which is favorable for reducing the back focal length. Moreover, the following condition can be satisfied: −1.75<TL/f5<−1.00.

When the curvature radius of the object-side surface of the first lens element is R1, and a curvature radius of the image-side surface of the fifth lens element is R10, the following condition is satisfied: 1.00<|R10/R1|<3.80. Therefore, the curvature radius of the object-side surface of the first lens element and the curvature radius of the image-side surface of the fifth lens element can be effectively balanced. The light path of the optical lens assembly is adjusted to make the first lens element and the fifth lens element in cooperation with each other, which is favorable for improving central imaging quality. Moreover, the following condition can be satisfied: 1.10<R10/R1|<2.50.

The optical lens assembly of the present disclosure can further include an aperture stop which is disposed on an object side of the third lens element. Therefore, the imaging area and the incident angle of light entering the image surface can be limited, which is favorable for enhancing the relative illumination at the peripheral field of view. Moreover, the aperture stop can be arranged at an object side of the second lens element. Moreover, the aperture stop can be arranged at an object side of the first lens element.

When the curvature radius of the image-side surface of the first lens element is R2, and the curvature radius of the image-side surface of the fifth lens element is R10, the following condition is satisfied: 0.4<R10/R2<8.5. Therefore, the ratio between the curvature radius of the image-side surface of the first lens element and the curvature radius of the image-side surface of the fifth lens element can be adjusted, and central spherical aberration and the astigmatism are corrected. Moreover, the following condition can be satisfied: 0.5<R10/R2<7.0.

At least one of the object-side surface and the image-side surface of each of at least three of the first lens element to the fifth lens element can be aspheric. Therefore, the flexibility of designing can be enhanced, which is favorable for reducing the volume, and compensating the distortion and off-axis aberration of the optical lens assembly.

When a maximum effective radius of the object-side surface of the first lens element is Y1R1, and the maximum image height of the optical lens assembly is ImgH, the following condition is satisfied: 0.13<Y1R1/ImgH<0.25. Therefore, the optical effective radius height of the object-side surface of the first lens element can be adjusted, which is favorable for enlarging the imaging size and reducing the outer radius at the object side end of the optical lens assembly. Moreover, the following condition can be satisfied: 0.17<Y1R1/ImgH<0.23.

When a distance in parallel with the optical axis from an axial vertex on the image-side surface of the fifth lens element to a maximum effective radius position on the image-side surface of the fifth lens element is SAG5R2, and the central thickness of the fifth lens element is CT5, the following condition is satisfied: −3.50<SAG5R2/CT5<−1.00. Therefore, the curved degree of peripheral surface shape of the image-side surface of the fifth lens element can be controlled to correct the distortion and the field curvature, and improve imaging quality. Moreover, the following condition can be satisfied: −3.00<SAG5R2/CT5<−1.20.

When the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, and the maximum among T12, T23, T34, T45 is ATmax, the following condition is satisfied: T45=ATmax. Therefore, there can be sufficient space at the image side end of the optical lens assembly, and the flexibility of designing is enhanced, which is favorable for correcting the field curvature and the distortion.

When the axial distance between the object-side surface of the first lens element and the image surface is TL, and an axial distance between the image-side surface of the fifth lens element and the image surface is BL, the following condition is satisfied: 4.50<TL/BL<7.00. Therefore, the back focal length of the optical lens assembly can be controlled so as to satisfy various applications.

When the axial distance between the third lens element and the fourth lens element is T34, and the axial distance between the fourth lens element and the fifth lens element is T45, the following condition is satisfied: 0.90<T45/T34<2.60. Therefore, the relative space arrangement of the fourth lens element and the front and rare lens elements thereof can be harmonized to reduce the manufacturing sensitivity. Moreover, the following condition can be satisfied: 1.00<T45/T34<2.50.

When the axial distance between the object-side surface of the first lens element and the image-side surface of the fifth lens element is TD, and the central thickness of the fifth lens element is CT5, the following condition is satisfied: 7.00<TD/CT5<15.00. Therefore, the ratio relationship between the length of arranging the lens elements and the central thickness of the fifth lens element can be controlled, which is favorable for reducing the deviation of light convergence on the image surface. Moreover, the following condition can be satisfied: 7.80<TD/CT5<14.00.

When the Abbe number of the second lens element is V2, and the Abbe number of the third lens element is V3, the following condition is satisfied: 0.20<V2/V3<0.48. Therefore, the material arrangement of the second lens element and the third lens element can be harmonized, which is favorable for simultaneously reducing the generation of chromatic aberration when the light path folds.

When a distance in parallel with the optical axis from an axial vertex on the object-side surface of the fourth lens element to a maximum effective radius position on the object-side surface of the fourth lens element is SAG4R1, and a distance in parallel with the optical axis between the maximum effective radius position of the object-side surface of the fourth lens element and a maximum effective radius position of the image-side surface of the fourth lens element is ET4, the following condition is satisfied: −1.60<SAG4R1/ET4<−0.25. Therefore, the peripheral surface shape and the peripheral thickness of the fourth lens element can be adjusted to correct astigmatism, and reduce the stray light of the optical lens assembly. Moreover, the following condition can be satisfied: −1.50<SAG4R1/ET4<−0.35.

When a distance in parallel with the optical axis from an axial vertex on the object-side surface of the first lens element to a maximum effective radius position on the object-side surface of the first lens element is SAG1R1, and the curvature radius of the object-side surface of the first lens element is R1, the following condition is satisfied: 1.50<10×SAG1R1/R1<2.70. Therefore, the overall surface shape of the object-side surface of the first lens element can be controlled, which is favorable for reducing the generation of aberrations. The volume of the optical lens assembly is simultaneously decreased to meet the requirement of compactness. Moreover, the following condition can be satisfied: 1.60<10×SAG1R1/R1<2.60.

Each of the aforementioned features of the optical lens assembly can be utilized in various combinations for achieving the corresponding effects.

According to the optical lens assembly of the present disclosure, the lens elements thereof can be made of glass or plastic materials. When the lens elements are made of glass materials, the distribution of the refractive power of the optical lens assembly may be more flexible to design. The glass lens element can either be made by grinding or molding. When the lens elements are made of plastic materials, manufacturing costs can be effectively reduced. Furthermore, surfaces of each lens element can be arranged to be spherical or aspheric (ASP), wherein it is easier to fabricate the spherical surface. If the surfaces are arranged to be aspheric, more controllable variables can be obtained for eliminating aberrations thereof, and to further decrease the required amount of lens elements in the optical lens assembly. Therefore, the total track length of the optical lens assembly can also be reduced. The aspheric surfaces may be formed by plastic injection molding or glass molding.

According to the optical lens assembly of the present disclosure, one or more of the lens material may optionally include an additive which provides light absorption or light interference so as to alter the lens transmittance in a specific range of wavelength for reducing unwanted stray light or color deviation. For example, the additive may optionally filter out light in the wavelength range of 600 nm-800 nm for reducing excessive red light and/or near infra-red light, or may optionally filter out light in the wavelength range of 350 nm-450 nm to reduce excessive blue light and/or near ultra-violet light from interfering the final image. The additive may be homogenously mixed with plastic material to be used in manufacturing a mixed-material lens element by injection molding. Furthermore, the additive may be added in the coating on the lens element surface to achieve the aforementioned effects.

According to the optical lens assembly of the present disclosure, when a surface of a lens element is aspheric, it indicates that the surface has an aspheric shape throughout its optically effective area or a portion(s) thereof.

According to the optical lens assembly of the present disclosure, when the lens element has a convex surface, it indicates that the surface can be convex in the paraxial region thereof. When the lens element has a concave surface, it indicates that the surface can be concave in the paraxial region thereof. According to the optical lens assembly of the present disclosure, the refractive power or the focal length of a lens element being positive or negative may refer to the refractive power or the focal length in a paraxial region of the lens element.

According to the optical lens assembly of the present disclosure, a critical point is a non-axial point of the lens surface where its tangent is perpendicular to the optical axis; an inflection point is a point on a lens surface with a curvature changing from positive to negative or from negative to positive.

According to the optical lens assembly of the present disclosure, the image surface of the optical lens assembly, based on the corresponding image sensor, can be planar or curved. In particular, the image surface can be a concave curved surface facing towards the object side. According to the optical lens assembly of the present disclosure, at least one image correcting element (such as a field flattener) can be selectively disposed between the lens element closest to the image side of the optical lens assembly and the image surface on an imaging optical path so as to correct the image (such as the field curvature). Properties of the image correcting element, such as curvature, thickness, refractive index, position, surface shape (convex/concave, spherical/aspheric, diffractive and Fresnel, etc.) can be adjusted according to the requirements of the imaging apparatus. In general, the image correcting element is preferably a thin piano-concave element having a concave surface towards the object side and is disposed close to the image surface.

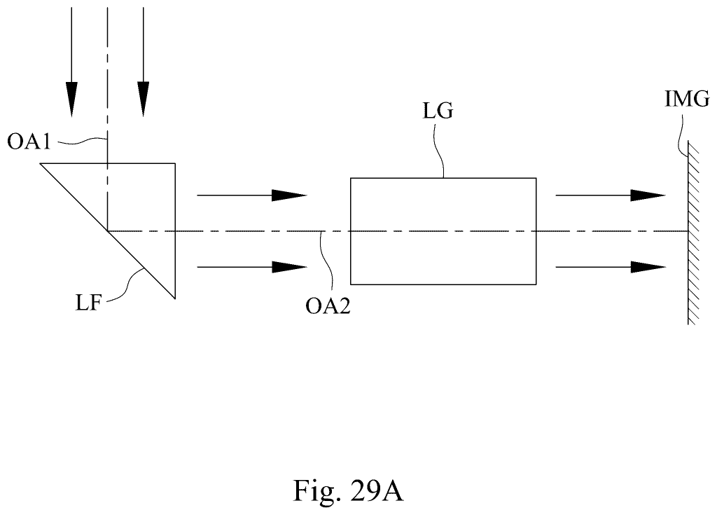

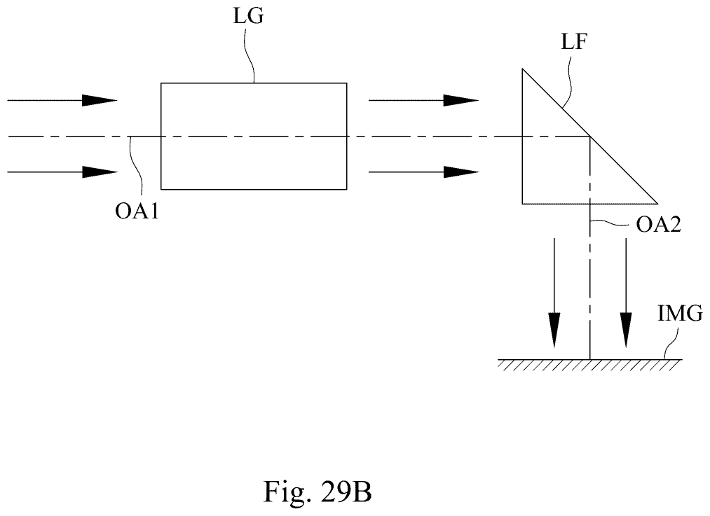

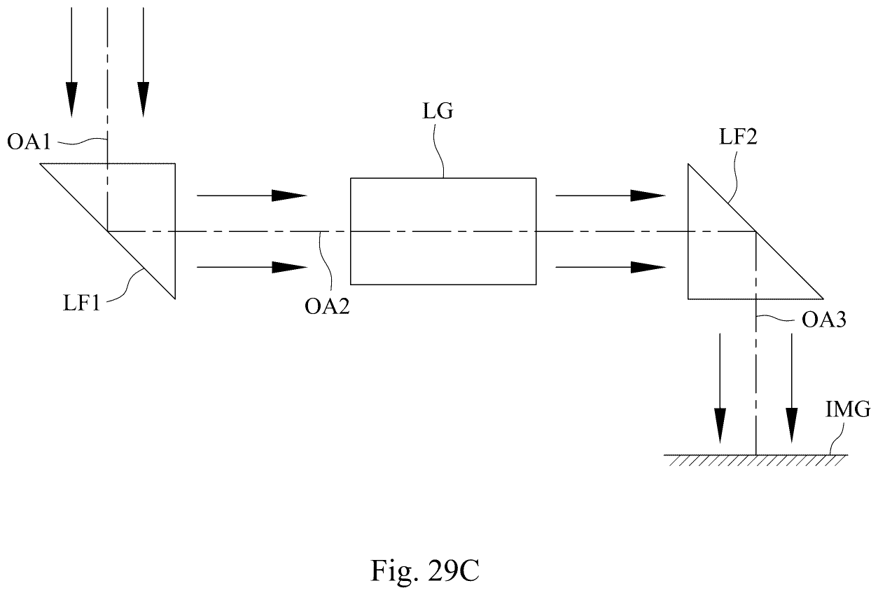

According to the optical lens assembly of the present disclosure, at least one element with light path folding function can be selectively disposed between the imaged object and the image surface, such as a prism or a mirror, wherein the prism surface or the mirror surface can be a planar surface, a spherical surface, an aspheric surface or a freeform surface. Therefore, it is favorable for providing high flexible space arrangement of the optical lens assembly, so that the compactness of the electronic device would not be restricted by the optical total track length of the optical lens assembly. FIG. 29A is a schematic view of an arrangement of a light path folding element LF in the optical lens assembly of the present disclosure. FIG. 29B is a schematic view of another arrangement of the light path folding element LF in the optical lens assembly of the present disclosure. As shown in FIG. 29A and FIG. 29B, the optical lens assembly includes, in order from an imaged object (not shown in drawings) to an image surface IMG, a first optical axis OA1, the light path folding element LF and a second optical axis OA2, wherein the light path folding element LF can be disposed between the imaged object and a lens group LG of the optical lens assembly as shown in FIG. 29A, or can be disposed between the lens group LG of the optical lens assembly and the image surface IMG as shown in FIG. 29B. Moreover, FIG. 29C is a schematic view of an arrangement of two light path folding elements LF1, LF2 in the optical lens assembly of the present disclosure. As shown in FIG. 29C, the optical lens assembly includes, in order from an imaged object (not shown in drawings) to an image surface IMG, a first optical axis OA1, the light path folding element LF1, a second optical axis OA2, the light path folding element LF2 and a third optical axis OA3, wherein the light path folding element LF1 is disposed between the imaged object and a lens group LG of the optical lens assembly, and the light path folding element LF2 is disposed between the lens group LG of the optical lens assembly and the image surface IMG. The optical lens assembly can also be selectively disposed with three or more light path folding elements, the type, amount and location of the light path folding elements will not be limited to the present disclosure.

According to the optical lens assembly of the present disclosure, the optical lens assembly can include at least one stop, such as an aperture stop, a glare stop or a field stop. Said glare stop or said field stop is for eliminating the stray light and thereby improving the image resolution thereof.

According to the optical lens assembly of the present disclosure, an aperture stop can be configured as a front stop or a middle stop. A front stop disposed between the imaged object and the first lens element can provide a longer distance between an exit pupil of the optical lens assembly and the image surface, and thereby obtains a telecentric effect and improves the image-sensing efficiency of the image sensor, such as CCD or CMOS. A middle stop disposed between the first lens element and the image surface is favorable for enlarging the field of view of the optical lens assembly and thereby provides a wide field of view for the same.

According to the optical lens assembly of the present disclosure, an aperture adjusting unit can be properly configured. The aperture adjusting unit can be a mechanical part or a light control part, and the dimension and the shape of the aperture adjusting unit can be electrically controlled. The mechanical part can include a moveable component such as a blade group or a shielding plate. The light control part can include a screen component such as a light filter, electrochromic material, a liquid crystal layer or the like. The amount of incoming light or the exposure time of the image can be controlled by the aperture adjusting unit to enhance the image moderation ability. In addition, the aperture adjusting unit can be the aperture stop of the optical lens assembly according to the present disclosure so as to moderate the image properties such as depth of field or the exposure speed by changing f-number.

According to the optical lens assembly of the present disclosure, one or more optical element can be properly configured so as to limit the way of light passing through the optical lens assembly. The aforementioned optical element can be a filter, a polarizer, etc., and it is not limited thereto. Moreover, the aforementioned optical element can be a single piece of element, a complex assembly or presented in a form of membrane, which is not limited thereto. The aforementioned optical element can be disposed at the object side, at the image side or between the lens elements of the optical lens assembly so as to allow the specific light to pass through, which will meet the requirements of applications.

According to the optical lens assembly of the present disclosure, the optical lens assembly can include at least one optical lens element, optical element or carrier, and at least one surface thereof includes a low-reflective layer. The stray light caused by the light reflecting at the interface can be effectively reduced by the low-reflective layer. The low-reflective layer can be disposed at the non-effective area of the object-side surface, at the non-effective area of the image-side surface or at the surface connecting the object-side surface and the image-side surface of the optical lens element. The optical element can be a light blocking element, an annular spacing element, a barrel member, a cover glass, a blue glass, a filter, a color filter, a light path folding element, a prism or a mirror, etc. The carrier can be a lens carrier for the lens assembly, a micro lens disposed on the image sensor, peripheral components of the image sensor substrate or a glass for protecting the image sensor, etc.

According to the optical lens assembly of the present disclosure, the optical lens assembly can be utilized in 3D (three-dimensional) image capturing applications, in products such as digital cameras, mobile devices, digital tablets, smart TVs, surveillance systems, motion sensing input devices, driving recording systems, rearview camera systems, wearable devices, and unmanned aerial vehicles.

According to the present disclosure, an imaging apparatus is provided. The imaging apparatus includes the aforementioned optical lens assembly and an image sensor, wherein the image sensor is disposed on the image surface of the aforementioned optical lens assembly. Through the arrangements of surface shapes and distances of the lens elements in the optical lens assembly, it is favorable for the compactness of the optical lens assembly, and the sensitivity thereof is reduced and the high imaging quality is maintained. Preferably, the imaging apparatus can further include a barrel member, a holder member or a combination thereof.

According to the present disclosure, an electronic device is provided, wherein the electronic device includes the aforementioned imaging apparatus. Therefore, it is favorable for enhancing the image quality. Preferably, the electronic device can further include, but not limited to, a control unit, a display, a storage unit, a random access memory unit (RAM) or a combination thereof.

According to the above description of the present disclosure, the following specific embodiments are provided for further explanation.

### 1st Embodiment

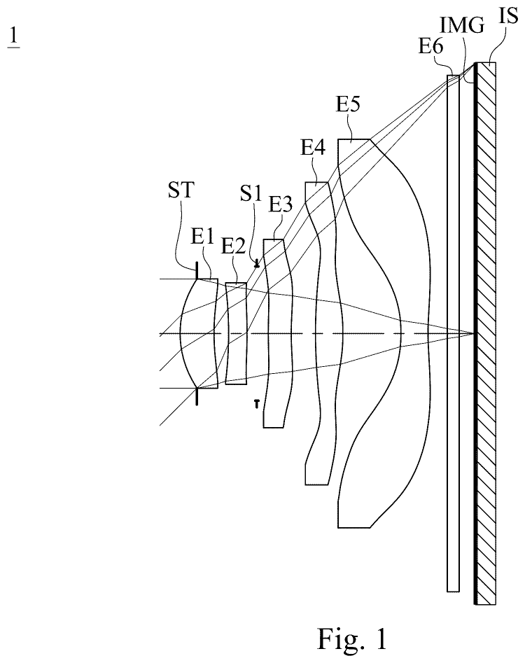

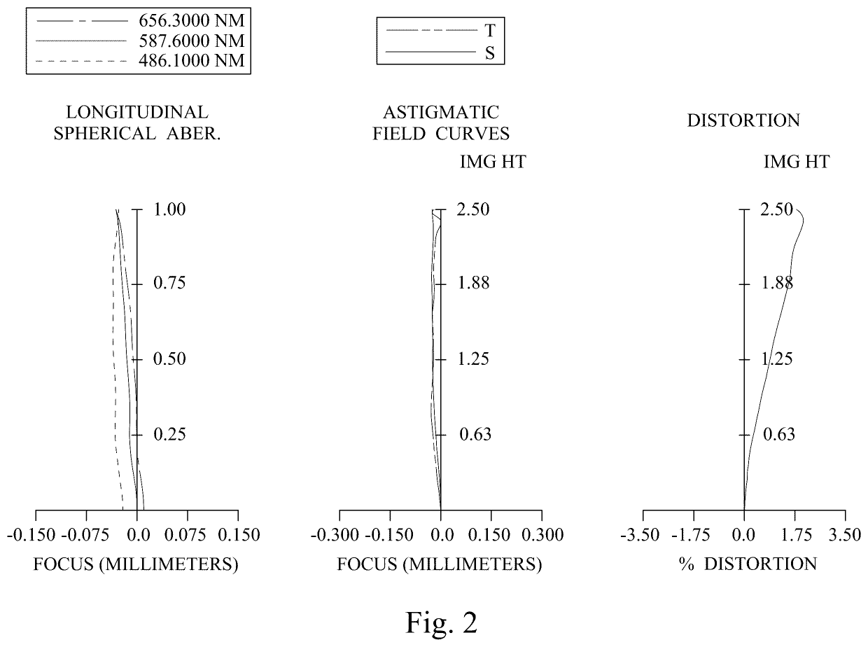

FIG. 1 is a schematic view of an imaging apparatus 1 according to the 1st embodiment of the present disclosure. FIG. 2 shows, in order from left to right, spherical aberration curves, astigmatic field curves and a distortion curve of the imaging apparatus according to the 1st embodiment. In FIG. 1, the imaging apparatus 1 according to the 1st embodiment includes an optical lens assembly (its reference number is omitted) and an image sensor IS. The optical lens assembly includes, in order from an object side to an image side along an optical path, an aperture stop ST, a first lens element E1, a second lens element E2, a stop S1, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

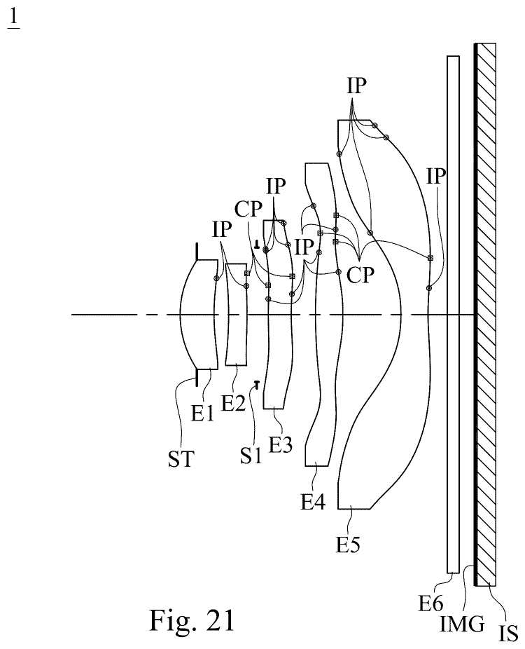

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, FIG. 21 is a schematic view of inflection points IP and critical points CP of each lens element in the 1st embodiment. The image-side surface of the first lens element E1 includes one inflection point IP (shown in FIG. 21).

The second lens element E2 with negative refractive power has an object-side surface being concave in a paraxial region thereof and an image-side surface being convex in a paraxial region thereof. The second lens element E2 is made of plastic material, and has the object-side surface and the image-side surface being both aspheric. Moreover, the image-side surface of the second lens element E2 includes one inflection point IP (shown in FIG. 21) and one critical point CP (shown in FIG. 21).

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Moreover, the object-side surface of the third lens element E3 includes three inflection points IP (shown in FIG. 21) and one critical point CP (shown in FIG. 21), the image-side surface of the third lens element E3 includes three inflection points IP (shown in FIG. 21) and one critical point CP (shown in FIG. 21).

The fourth lens element E4 with positive refractive power has an object-side surface being convex in a paraxial region thereof and an image-side surface being convex in a paraxial region thereof. The fourth lens element E4 is made of plastic material, and has the object-side surface and the image-side surface being both aspheric. Moreover, the object-side surface of the fourth lens element E4 includes two inflection points IP (shown in FIG. 21) and one critical point CP (shown in FIG. 21), the image-side surface of the fourth lens element E4 includes two inflection points IP (shown in FIG. 21) and two critical points CP (shown in FIG. 21).

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points IP (shown in FIG. 21), the image-side surface of the fifth lens element E5 includes three inflection points IP (shown in FIG. 21) and one critical point CP (shown in FIG. 21).

The filter E6 is made of glass material and disposed between the fifth lens element E5 and the image surface IMG and will not affect a focal length of the optical lens assembly.

The equation of the aspheric surface profiles of the aforementioned lens elements is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ;$$

wherein,
X is a displacement in parallel with an optical axis from the intersection point of the aspheric surface and the optical axis to a point at a distance Y from the optical axis on the aspheric surface;
Y is the vertical distance from the point on the aspheric surface to the optical axis;
R is the curvature radius;
k is the conic coefficient; and
Ai is the i-th aspheric coefficient.

In the optical lens assembly according to the 1st embodiment, when a focal length of the optical lens assembly is f, an f-number of the optical lens assembly is Fno, and half of a maximum field of view of the optical lens assembly is HFOV, these parameters have the following values: f=2.47 mm; Fno=2.44; and HFOV=45.1 degrees.

In the optical lens assembly according to the 1st embodiment, when the maximum field of view of the optical lens assembly is FOV, the following condition is satisfied: FOV=90.2 degrees.

In the optical lens assembly according to the 1st embodiment, when an axial distance between the object-side surface of the first lens element E1 and the image surface IMG is TL, and a maximum image height of the optical lens assembly is ImgH, the following condition is satisfied: TL/ImgH=1.09.

In the optical lens assembly according to the 1st embodiment, when the half of the maximum field of view of the optical lens assembly is HFOV, the following condition is satisfied: tan(HFOV)=1.00.

In the optical lens assembly according to the 1st embodiment, when an axial distance between the object-side surface of the first lens element E1 and the image-side surface of the fifth lens element E5 is TD, and an entrance pupil diameter of the optical lens assembly is EPD, the following condition is satisfied: TD/EPD=2.27.

In the optical lens assembly according to the 1 st embodiment, when the axial distance between the object-side surface of the first lens element E1 and the image surface IMG is TL, an axial distance between the image-side surface of the fifth lens element E5 and the image surface IMG is BL, a focal length of the fifth lens element E5 is f5, and a central thickness of the fourth lens element E4 is CT4, the following conditions are satisfied: TL/BL=6.21; TL/f5=−1.74; and TL/CT4=10.79.

In the optical lens assembly according to the 1st embodiment, when a focal length of the first lens element E1 is f1, and the focal length of the fifth lens element E5 is f5, the following condition is satisfied: f1/f5=−1.58.

In the optical lens assembly according to the 1st embodiment, when the focal length of the optical lens assembly is f, and a composite focal length of the first lens element E1 and the second lens element E2 is f12, the following condition is satisfied: f/f12=0.85.

In the optical lens assembly according to the 1st embodiment, when the focal length of the optical lens assembly is f, a focal length of the third lens element E3 is f3, and a focal length of the fourth lens element E4 is f4, the following condition is satisfied: |f/f3|+|f/f4|=1.25.

In the optical lens assembly according to the 1st embodiment, when the focal length of the optical lens assembly is f, a curvature radius of the image-side surface of the first lens element E1 is R2, and a curvature radius of the image-side surface of the second lens element E2 is R4, the following condition is satisfied: |f/R2|−|f/R4|=0.75.

In the optical lens assembly according to the 1st embodiment, when the curvature radius of the image-side surface of the first lens element E1 is R2, and the axial distance between the object-side surface of the first lens element E1 and the image-side surface of the fifth lens element E5 is TD, the following condition is satisfied: R2/TD=0.98.

In the optical lens assembly according to the 1st embodiment, when a curvature radius of the object-side surface of the fourth lens element E4 is R7, and a composite focal length of the fourth lens element E4 and the fifth lens element E5 is f45, the following condition is satisfied: R7/f45=−0.15.

In the optical lens assembly according to the 1st embodiment, when a curvature radius of the object-side surface of the first lens element E1 is R1, the curvature radius of the image-side surface of the first lens element E1 is R2, a curvature radius of the object-side surface of the fifth lens element E5 is R9, and a curvature radius of the image-side surface of the fifth lens element E5 is R10, the following conditions are satisfied: |R2/R1 I=2.54; |R9/R1 I=1.49; |R10/R1 I=2.78; and R10/R2=1.09.

In the optical lens assembly according to the 1st embodiment, when an axial distance between the first lens element E1 and the second lens element E2 is T12, an axial distance between the second lens element E2 and the third lens element E3 is T23, an axial distance between the third lens element E3 and the fourth lens element E4 is T34, an axial distance between the fourth lens element E4 and the fifth lens element E5 is T45, a maximum among T12, T23, T34, T45 is ATmax, and a minimum among T12, T23, T34, T45 is ATmin, the following condition is satisfied: ATmax/ATmin=4.01; wherein in the 1st embodiment, ATmax=T45.

In the optical lens assembly according to the 1st embodiment, when a central thickness of the first lens element E1 is CT1, a central thickness of the second lens element E2 is CT2, a central thickness of the third lens element E3 is CT3, the central thickness of the fourth lens element E4 is CT4, a central thickness of the fifth lens element E5 is CT5, a maximum among CT1, CT2, CT3, CT4, CT5 is CTmax, and a minimum among CT1, CT2, CT3, CT4, CT5 is CTmin, the following condition is satisfied: CTmax/CTmin=1.85.

In the optical lens assembly according to the 1st embodiment, when the central thickness of the first lens element E1 is CT1, the central thickness of the second lens element E2 is CT2, the central thickness of the third lens element E3 is CT3, the central thickness of the fourth lens element E4 is CT4, the central thickness of the fifth lens element E5 is CT5, a sum of all central thicknesses of the five lens elements of the optical lens assembly is ∈CT, the axial distance between the first lens element E1 and the second lens element E2 is T12, the axial distance between the second lens element E2 and the third lens element E3 is T23, the axial distance between the third lens element E3 and the fourth lens element E4 is T34, the axial distance between the fourth lens element E4 and the fifth lens element E5 is T45, and a sum of all axial distances between adjacent lens elements of the optical lens assembly is ΣAT, the following condition is satisfied: ΣCT/ΣAT=1.10; wherein in the 1st embodiment, ΣCT=CT1+CT2+CT3+CT4+CT5, ΣAT=T12+T23+T34+T45.

In the optical lens assembly according to the 1st embodiment, when the axial distance between the object-side surface of the first lens element E1 and the image-side surface of the fifth lens element E5 is TD, and the central thickness of the fifth lens element E5 is CT5, the following condition is satisfied: TD/CT5=9.16.

In the optical lens assembly according to the 1st embodiment, when the axial distance between the third lens element E3 and the fourth lens element E4 is T34, and the central thickness of the second lens element E2 is CT2, the following condition is satisfied: T34/CT2=1.32.

In the optical lens assembly according to the 1st embodiment, when the axial distance between the third lens element E3 and the fourth lens element E4 is T34, and the axial distance between the fourth lens element E4 and the fifth lens element E5 is T45, the following condition is satisfied: T45/T34=2.40.

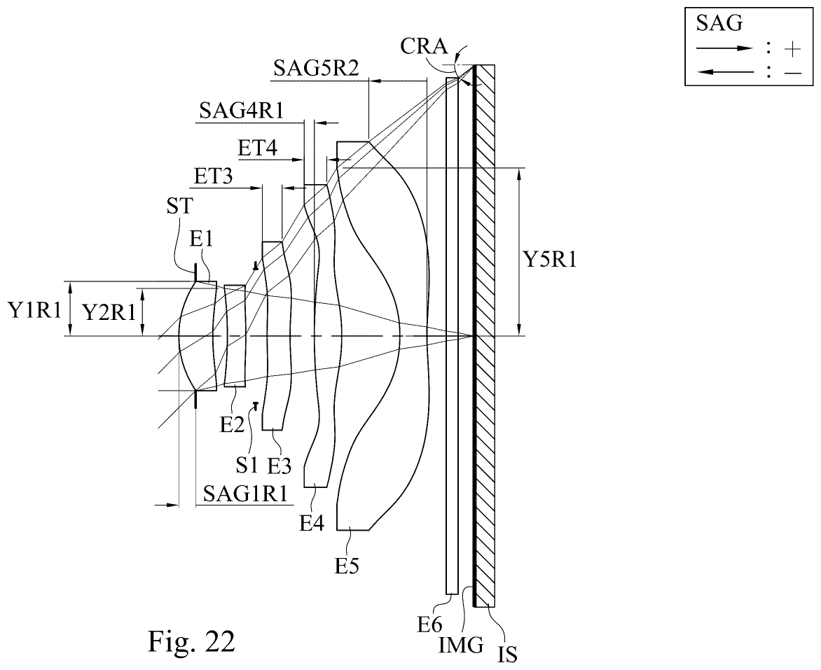

FIG. 22 is a schematic view of part of parameters of the 1st embodiment. In FIG. 22, In the optical lens assembly according to the 1st embodiment, when a distance in parallel with the optical axis between a maximum effective radius position of the object-side surface of the third lens element E3 and a maximum effective radius position of the image-side surface of the third lens element E3 is ET3, and the central thickness of the third lens element E3 is CT3, the following condition is satisfied: CT3/ET3=1.16.

In the optical lens assembly according to the 1st embodiment, when an incident angle between a chief ray in the maximum field of view of the optical lens assembly and the image surface IMG is CRA (shown in FIG. 22), the following condition is satisfied: tan(CRA)=0.87.

In the optical lens assembly according to the 1st embodiment, when an Abbe number of the first lens element E1 is V1, an Abbe number of the second lens element E2 is V2, an Abbe number of the third lens element E3 is V3, an Abbe number of the fourth lens element E4 is V4, an Abbe number of the fifth lens element E5 is V5, and a minimum among V1, V2, V3, V4, V5 is Vmin, the following conditions are satisfied: Vmin=18.4; V1/V2=3.05; and V2/V3=0.33.

In the optical lens assembly according to the 1st embodiment, when a distance in parallel with the optical axis from an axial vertex on the image-side surface of the fifth lens element E5 to a maximum effective radius position on the image-side surface of the fifth lens element E5 is SAG5R2 (shown in FIG. 22), and the central thickness of the fifth lens element E5 is CT5, the following condition is satisfied: SAG5R2/CT5=−2.15; wherein SAG5R2 towards the object side has a negative value, SAG5R2 towards the image side has a positive value.

In the optical lens assembly according to the 1st embodiment, when a distance in parallel with the optical axis from an axial vertex on the object-side surface of the first lens element E1 to a maximum effective radius position on the object-side surface of the first lens element E1 is SAG1R1 (shown in FIG. 22), and the curvature radius of the object-side surface of the first lens element E1 is R1, the following condition is satisfied: 10×SAG1R1/R1=1.80; wherein SAG1R1 towards the object side has a negative value, SAG1R1 towards the image side has a positive value.

In the optical lens assembly according to the 1st embodiment, when a distance in parallel with the optical axis from an axial vertex on the object-side surface of the fourth lens element E4 to a maximum effective radius position on the object-side surface of the fourth lens element E4 is SAG4R1 (shown in FIG. 22), and a distance in parallel with the optical axis between the maximum effective radius position of the object-side surface of the fourth lens element E4 and a maximum effective radius position of the image-side surface of the fourth lens element E4 is ET4 (shown in FIG. 22), the following condition is satisfied: SAG4R1/ET4=−0.45; wherein SAG4R1 towards the object side has a negative value, SAG4R1 towards the image side has a positive value.

In the optical lens assembly according to the 1st embodiment, when a maximum effective radius of the object-side surface of the second lens element E2 is Y2R1 (shown in FIG. 22), and a maximum effective radius of the object-side surface of the fifth lens element E5 is Y5R1 (shown in FIG. 22), the following condition is satisfied: Y5R1/Y2R1=3.48.

In the optical lens assembly according to the 1st embodiment, when a maximum effective radius of the object-side surface of the first lens element E1 is Y1R1 (shown in FIG. 22), and the maximum image height of the optical lens assembly is ImgH, the following condition is satisfied: Y1R1/ImgH=0.20.

The detailed optical data of the 1st embodiment are shown in Table 1A and the aspheric surface data are shown in Table 1B below.

TABLE 1A
1st Embodiment
f = 2.47 mm, Fno = 2.44, HFOV = 45.1 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.155 | | | | |
| 2 | Lens 1 | 0.8833 | ASP | 0.314 | Plastic | 1.545 | 56.1 | 2.47 |
| 3 | | 2.2460 | ASP | 0.134 | | | | |
| 4 | Lens 2 | −4.1651 | ASP | 0.170 | Plastic | 1.686 | 18.4 | −15.11 |
| 5 | | −7.0793 | ASP | 0.091 | | | | |
| 6 | Stop | Plano | | 0.106 | | | | |
| 7 | Lens 3 | 3.7642 | ASP | 0.212 | Plastic | 1.544 | 56.0 | −13.00 |
| 8 | | 2.4077 | ASP | 0.224 | | | | |
| 9 | Lens 4 | 4.4517 | ASP | 0.253 | Plastic | 1.545 | 56.1 | 2.33 |
| 10 | | −1.7398 | ASP | 0.537 | | | | |
| 11 | Lens 5 | −1.3148 | ASP | 0.250 | Plastic | 1.534 | 56.0 | −1.57 |
| 12 | | 2.4563 | ASP | 0.178 | | | | |

| | | | | | | | |
|---|---|---|---|---|---|---|---|
| 13 | Filter | Plano | 0.110 | Glass | 1.517 | 64.2 | — |
| 14 | | Plano | 0.152 | | | | |
| 15 | Image | Plano | — | | | | |

Reference wavelength is 587.6 nm (d-line).
Effective radius of Surface 6 (Stop S1) is 0.620 mm.

TABLE 1B
Aspheric Coefficients

| Surface # | 2 | 3 | 4 | 5 | 7 |
|---|---|---|---|---|---|
| k = | −3.673690000E−01 | 3.478470000E+00 | 0.000000000E+00 | 0.000000000E+00 | 0.000000000E+00 |
| A4 = | 3.727529145E−02 | −1.196219875E−01 | −2.358425027E−02 | −3.700404605E−01 | −1.203772093E+00 |
| A6 = | 9.034209865E−01 | −1.830339875E+00 | −1.233513895E+01 | 1.184298832E+01 | 5.102607764E+00 |
| A8 = | −8.488257213E+00 | 2.330798496E+01 | 4.848046006E+02 | −2.695573005E+02 | −3.699685488E+01 |
| A10 = | 4.255771505E+01 | −2.420472900E+02 | −1.131494698E+04 | 4.574856647E+03 | 2.402227599E+02 |
| A12 = | −1.077274409E+02 | 1.286766500E+03 | 1.725358422E+05 | −5.147650928E+04 | −1.121444472E+03 |
| A14 = | 8.684638836E+01 | −3.617028605E+03 | −1.774033211E+06 | 3.921240921E+05 | 3.665002023E+03 |
| A16 = | | 4.149289209E+03 | 1.249538391E+07 | −2.025497003E+06 | −7.980682988E+03 |
| A18 = | | | −6.031506102E+07 | 6.980961932E+06 | 1.084838096E+04 |
| A20 = | | | 1.959780230E+08 | −1.535358893E+07 | −8.279569476E+03 |
| A22 = | | | −4.094314139E+08 | 1.946899745E+07 | 2.706316513E+03 |
| A24 = | | | 4.965029361E+08 | −1.081712009E+07 | |
| A26 = | | | −2.655178602E+08 | | |
| Surface # | 8 | 9 | 10 | 11 | 12 |
| k = | −7.216300000E−01 | 0.000000000E+00 | −1.000000000E+00 | −1.000000000E+00 | −1.000000000E+00 |
| A4 = | −1.171153532E+00 | −1.417051011E−01 | 1.005484209E−01 | −8.578207015E−01 | −8.533704741E−01 |
| A6 = | 3.115727133E+00 | 5.632723300E−02 | 9.723600088E−01 | 3.099289373E+00 | 2.345588569E+00 |
| A8 = | −1.028642959E+01 | 4.415261977E+00 | −4.773548298E+00 | −8.484022238E+00 | −5.250047804E+00 |
| A10 = | 1.504055422E+00 | −2.554602375E+01 | 2.668606626E+01 | 1.906541809E+01 | 8.577283537E+00 |
| A12 = | 1.921694648E+02 | 7.588008413E+01 | −9.083089293E+01 | −3.494783009E+01 | −9.935248154E+00 |
| A14 = | −1.053499242E+03 | −1.463779628E+02 | 1.857545597E+02 | 5.201868448E+01 | 7.905383312E+00 |
| A16 = | 3.079588773E+03 | 1.894161949E+02 | −2.483533121E+02 | −5.941530019E+01 | −4.038839067E+00 |
| A18 = | −5.538507517E+03 | −1.635184522E+02 | 2.286538329E+02 | 4.961375858E+01 | 1.033839178E+00 |
| A20 = | 6.203745986E+03 | 9.245358167E+01 | −1.484459128E+02 | −2.955552402E+01 | 1.347876888E−01 |
| A22 = | −4.162513140E+03 | −3.281757294E+01 | 6.811821358E+01 | 1.235281150E+01 | −2.220587406E−01 |
| A24 = | 1.501338028E+03 | 6.631233856E+00 | −2.168620751E+01 | −3.532956913E+00 | 8.731200576E−02 |
| A26 = | −2.155832054E+02 | −5.817913386E−01 | 4.567103303E+00 | 6.583547188E−01 | −1.816766282E−02 |
| A28 = | | | −5.731209136E−01 | −7.203296675E−02 | 2.029985466E−03 |
| A30 = | | | 3.248520416E−02 | 3.511579798E−03 | −9.615585736E−05 |

Table 1A shows the detailed optical data of FIG. 1A of the 1st embodiment, wherein the curvature radius, thickness and the focal length are shown in millimeters (mm), surface numbers 0-15 represent the surfaces sequentially arranged from the object side to the image side, and the refractive index is measured in accordance with the reference wavelength. Table 1B shows the aspheric surface data of the 1st embodiment, wherein k represents the conic coefficient of the equation of the aspheric surface profiles, and A4-A30 represent the aspheric coefficients of each surface ranging from the 4th order to the 30th order. The tables presented below for each embodiment correspond to the schematic view and aberration curves of each embodiment, and term definitions of the tables are the same as those in Table 1A and Table 1B of the 1st embodiment. Therefore, an explanation in this regard will not be provided again.

### 2nd Embodiment

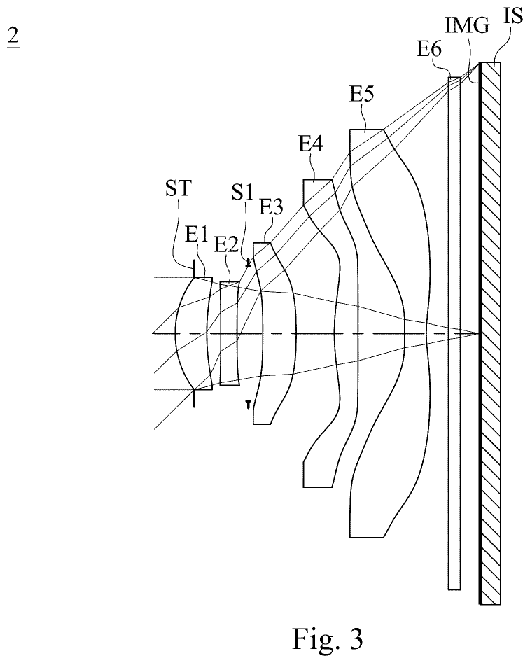

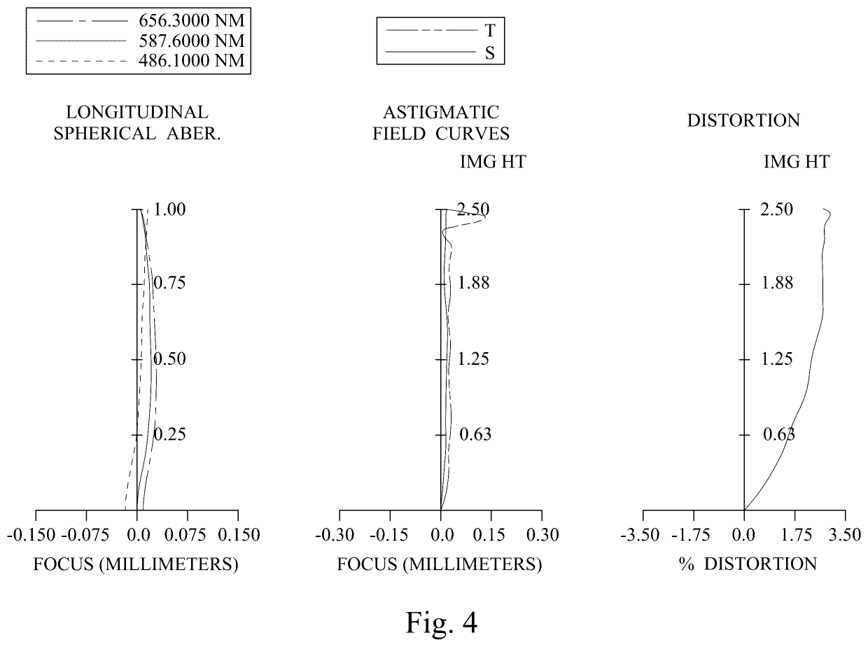

FIG. 3 is a schematic view of an imaging apparatus 2 according to the 2nd embodiment of the present disclosure. FIG. 4 shows, in order from left to right, spherical aberration curves, astigmatic field curves and a distortion curve of the imaging apparatus according to the 2nd embodiment. In FIG. 3, the imaging apparatus 2 according to the 2nd embodiment includes an optical lens assembly (its reference number is omitted) and an image sensor IS. The optical lens assembly includes, in order from an object side to an image side along an optical path, an aperture stop ST, a first lens element E1, a second lens element E2, a stop S1, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of glass material, and has the object-side surface and the image-side surface being both aspheric. Moreover, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points and one critical point.

The third lens element E3 with positive refractive power has an object-side surface being concave in a paraxial region thereof and an image-side surface being convex in a paraxial region thereof. The third lens element E3 is made of glass material, and has the object-side surface and the image-side surface being both aspheric. Moreover, the object-side surface of the third lens element E3 includes one inflection point, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes three inflection points and one critical point, the image-side surface of the fourth lens element E4 includes five inflection points and three critical points.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes three inflection points, the image-side surface of the fifth lens element E5 includes four inflection points and one critical point.

The filter E6 is made of glass material and disposed between the fifth lens element E5 and the image surface IMG and will not affect a focal length of the optical lens assembly.

The detailed optical data of the 2nd embodiment are shown in Table 2A and the aspheric surface data are shown in Table 2B below.

TABLE 2A
2nd Embodiment
f = 2.44 mm, Fno = 2.35, HFOV = 44.7 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.176 | | | | |
| 2 | Lens 1 | 0.8672 | ASP | 0.292 | Glass | 1.518 | 58.9 | 2.68 |
| 3 | | 2.0423 | ASP | 0.129 | | | | |
| 4 | Lens 2 | 68.7595 | ASP | 0.150 | Plastic | 1.697 | 16.3 | −14.55 |
| 5 | | 8.8322 | ASP | 0.104 | | | | |
| 6 | Stop | Plano | | 0.135 | | | | |
| 7 | Lens 3 | −10.2071 | ASP | 0.308 | Glass | 1.548 | 45.8 | 12.94 |
| 8 | | −4.2301 | ASP | 0.352 | | | | |
| 9 | Lens 4 | 1.6911 | ASP | 0.219 | Plastic | 1.544 | 56.0 | 3.90 |
| 10 | | 7.9298 | ASP | 0.431 | | | | |
| 11 | Lens 5 | −7.8532 | ASP | 0.200 | Plastic | 1.511 | 56.8 | −1.91 |
| 12 | | 1.1230 | ASP | 0.205 | | | | |

| | | | | | | | |
|---|---|---|---|---|---|---|---|
| 13 | Filter | Plano | 0.110 | Glass | 1.517 | 64.2 | — |
| 14 | | Plano | 0.186 | | | | |
| 15 | Image | Plano | — | | | | |

Reference wavelength is 587.6 nm (d-line).
Effective radius of Surface 6 (Stop S1) is 0.625 mm.

TABLE 2B
Aspheric Coefficients

| Surface # | 2 | 3 | 4 | 5 | 7 |
|---|---|---|---|---|---|
| k = | −3.512120000E−01 | 3.747780000E+00 | 9.000000000E+01 | −9.000000000E+01 | 6.381620000E+01 |
| A4 = | −1.475276331E−03 | −1.515218993E−01 | −3.569131533E−01 | −1.154189475E−01 | −6.701047468E−01 |
| A6 = | 4.180599708E+00 | 1.739257594E−01 | 1.972994807E+00 | 9.323817061E−01 | 4.521704019E+00 |
| A8 = | −8.894039702E+01 | −1.415134506E+01 | −4.802512276E+01 | 4.466028775E+00 | −5.701970372E+01 |
| A10 = | 1.175093252E+03 | 2.439069118E+02 | 1.219835566E+03 | −4.927620353E+01 | 4.849174786E+02 |
| A12 = | −9.540125821E+03 | −2.455665533E+03 | −2.146224310E+04 | 4.464837139E+02 | −2.795584717E+03 |
| A14 = | 4.812579584E+04 | 1.514312272E+04 | 2.594206698E+05 | −2.172216893E+03 | 1.111805088E+04 |
| A16 = | −1.466479805E+05 | −5.599990818E+04 | −2.140676486E+06 | 6.125492294E+03 | −3.044963529E+04 |
| A18 = | 2.468730957E+05 | 1.135084689E+05 | 1.198195353E+07 | −9.928998125E+03 | 5.716327750E+04 |
| A20 = | −1.761189648E+05 | −9.676438352E+04 | −4.461434356E+07 | 7.664766954E+03 | −7.122590990E+04 |
| A22 = | | | 1.055277265E+08 | | 5.335374808E+04 |
| A24 = | | | −1.431580422E+08 | | −1.812517509E+04 |
| A26 = | | | 8.464540844E+07 | | |
| Surface # | 8 | 9 | 10 | 11 | 12 |
| k = | 8.142500000E+00 | −1.753510000E+01 | 1.622350000E+01 | 3.413540000E+00 | −1.407750000E+01 |
| A4 = | −8.732686769E−01 | −6.480175875E−01 | −9.659957511E−01 | −3.313425236E+00 | −1.583548995E+00 |
| A6 = | 4.884960697E+00 | 5.287979454E+00 | 5.576594043E+00 | 1.386650889E+01 | 6.232952967E+00 |
| A8 = | −4.543588654E+01 | −3.287111344E+01 | −1.923153943E+01 | −3.613300740E+01 | −1.542275619E+01 |
| A10 = | 3.053387070E+02 | 1.667124431E+02 | 5.562930268E+01 | 6.385718596E+01 | 2.655233188E+01 |
| A12 = | −1.482824023E+03 | −6.866195672E+02 | −1.480410465E+02 | −7.695255743E+01 | −3.343357572E+01 |
| A14 = | 5.155579417E+03 | 2.100088414E+03 | 3.072931047E+02 | 6.339153642E+01 | 3.141401771E+01 |
| A16 = | −1.254331214E+04 | −4.658532245E+03 | −4.560677721E+02 | −3.543542618E+01 | −2.211324160E+01 |
| A18 = | 2.066903548E+04 | 7.428649102E+03 | 4.775894743E+02 | 1.292072934E+01 | 1.160893435E+01 |
| A20 = | −2.176469137E+04 | −8.431697706E+03 | −3.533169491E+02 | −2.645156149E+00 | −4.496693137E+00 |
| A22 = | 1.310541048E+04 | 6.712430702E+03 | 1.835469285E+02 | 5.582430919E−02 | 1.261594883E+00 |
| A24 = | −3.413325208E+03 | −3.651501076E+03 | −6.550481199E+01 | 1.291766246E−01 | −2.484406424E−01 |
| A26 = | | 1.290976150E+03 | 1.529347341E+01 | −3.626864027E−02 | 3.248183640E−02 |
| A28 = | | −2.671748732E+02 | −2.103509529E+00 | 4.461860139E−03 | −2.527081874E−03 |
| A30 = | | 2.455994813E+01 | 1.292419165E−01 | −2.204495284E−04 | 8.841536879E−05 |

In the 2nd embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 2nd embodiment, so an explanation in this regard will not be provided again.

Moreover, these parameters can be calculated from Table 2A and Table 2B as the following values and satisfy the following conditions:

TABLE 2C
2nd Embodiment

| | | | |
|---|---|---|---|
| f [mm] | 2.44 | \|R10/R1\| | 1.29 |
| Fno | 2.35 | R10/R2 | 0.55 |
| HFOV [deg.] | 44.7 | ATmax/ATmin | 3.34 |
| FOV [deg.] | 89.4 | CTmax/CTmin | 2.05 |
| TL/ImgH | 1.13 | ΣCT/ΣAT | 1.02 |
| tan(HFOV) | 0.99 | TD/CT5 | 11.60 |
| TD/EPD | 2.24 | T34/CT2 | 2.35 |
| TL/BL | 5.63 | T45/T34 | 1.22 |
| TL/f5 | −1.48 | CT3/ET3 | 1.95 |
| TL/CT4 | 12.88 | tan(CRA) | 0.86 |
| f1/f5 | −1.40 | Vmin | 16.3 |
| f/f12 | 0.78 | V1/V2 | 3.62 |
| \|f/f3\| + \|f/f4\| | 0.81 | V2/V3 | 0.35 |
| \|f/R2\| − \|f/R4\| | 0.92 | SAG5R2/CT5 | −1.98 |
| R2/TD | 0.88 | 10×SAG1R1/R1 | 2.09 |
| R7/f45 | −0.29 | SAG4R1/ET4 | −1.08 |
| \|R2/R1\| | 2.36 | Y5R1/Y2R1 | 3.67 |
| \|R9/R1\| | 9.06 | Y1R1/ImgH | 0.21 |

### 3rd Embodiment

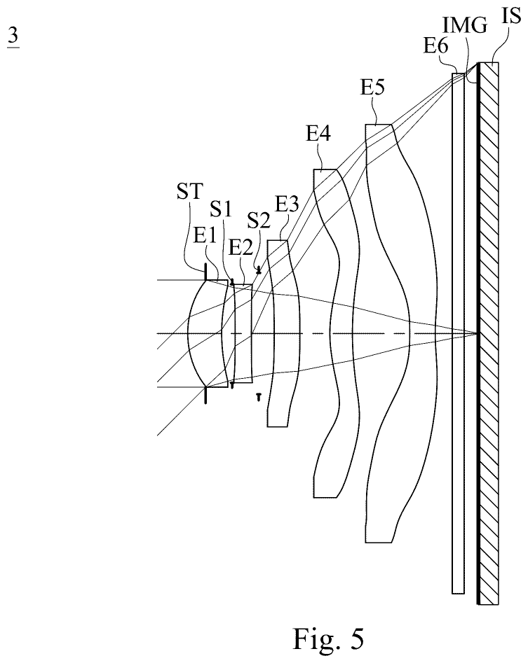

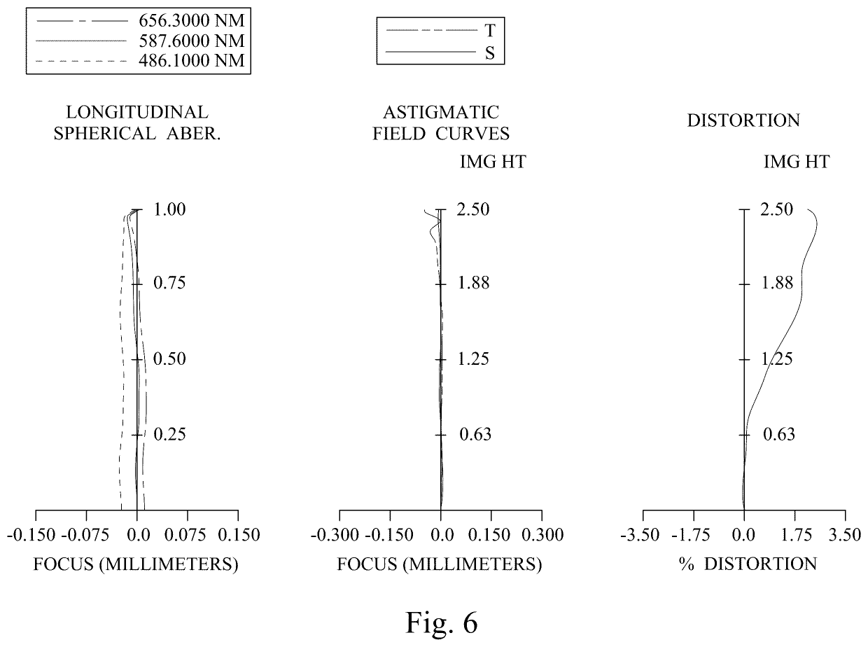

FIG. 5 is a schematic view of an imaging apparatus 3 according to the 3rd embodiment of the present disclosure. FIG. 6 shows, in order from left to right, spherical aberration curves, astigmatic field curves and a distortion curve of the imaging apparatus according to the 3rd embodiment. In FIG. 5, the imaging apparatus 3 according to the 3rd embodiment includes an optical lens assembly (its reference number is omitted) and an image sensor IS. The optical lens assembly includes, in order from an object side to an image side along an optical path, an aperture stop ST, a first lens element E1, a stop S1, a second lens element E2, a stop S2, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes one inflection point and one critical point, the image-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes three inflection points and one critical point, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes four inflection points and one critical point, the image-side surface of the fourth lens element E4 includes one inflection point and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points and two critical points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 3rd embodiment are shown in Table 3A and the aspheric surface data are shown in Table 3B below.

TABLE 3A
3rd Embodiment
f = 2.44 mm, Fno = 2.47, HFOV = 45.1 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.165 | | | | |
| 2 | Lens 1 | 0.8254 | ASP | 0.313 | Plastic | 1.545 | 56.1 | 2.67 |
| 3 | | 1.6556 | ASP | 0.097 | | | | |
| 4 | Stop | Plano | | 0.027 | | | | |
| 5 | Lens 2 | 99.0099 | ASP | 0.150 | Plastic | 1.686 | 18.4 | −21.14 |
| 6 | | 12.6437 | ASP | 0.068 | | | | |
| 7 | Stop | Plano | | 0.142 | | | | |
| 8 | Lens 3 | 80.8894 | ASP | 0.237 | Plastic | 1.545 | 56.1 | 81.73 |
| 9 | | −99.0099 | ASP | 0.277 | | | | |
| 10 | Lens 4 | 1.2292 | ASP | 0.208 | Plastic | 1.544 | 56.0 | 3.86 |
| 11 | | 2.7912 | ASP | 0.529 | | | | |
| 12 | Lens 5 | −2.4711 | ASP | 0.235 | Plastic | 1.534 | 55.9 | −1.89 |
| 13 | | 1.7552 | ASP | 0.157 | | | | |

| | | | | | | | |
|---|---|---|---|---|---|---|---|
| 14 | Filter | Plano | 0.110 | Glass | 1.517 | 64.2 | — |
| 15 | | Plano | 0.132 | | | | |
| 16 | Image | Plano | — | | | | |

Reference wavelength is 587.6 nm (d-line).
Effective radius of Surface 4 (Stop S1) is 0.455 mm.
Effective radius of Surface 7 (Stop S2) is 0.560 mm.

TABLE 3B
Aspheric Coefficients

| Surface # | 2 | 3 | 5 | 6 | 8 |
|---|---|---|---|---|---|
| k = | −1.379210000E−01 | 3.643160000E+00 | 0.000000000E+00 | 0.000000000E+00 | 0.000000000E+00 |
| A4 = | 1.104967716E−02 | −2.558240017E−01 | −2.032843495E−01 | −4.181998584E−01 | −1.117246231E+00 |
| A6 = | −2.057298311E+00 | 1.167174839E+01 | −1.447371554E+01 | 9.661598977E+00 | 1.427298317E+01 |
| A8 = | 3.322275601E+02 | −5.434300792E+02 | 6.413804854E+02 | −3.153930259E+02 | −2.408754545E+02 |
| A10 = | −1.403926799E+04 | 1.445510045E+04 | −1.867786757E+04 | 7.747887946E+03 | 2.959631513E+03 |
| A12 = | 3.292849337E+05 | 2.341649234E+05 | 3.723618232E+05 | −1.310106407E+05 | −2.539304199E+04 |
| A14 = | −4.912606863E+06 | 2.193739750E+06 | −5.181834919E+06 | 1.553850279E+06 | 1.540899348E+05 |
| A16 = | 4.930418125E+07 | −8.299099326E+06 | 5.100401029E+07 | −1.305456525E+07 | −6.675529018E+05 |
| A18 = | −3.409017101E+08 | −5.345044514E+07 | −3.570178375E+08 | 7.803640516E+07 | 2.069475281E+06 |
| A20 = | 1.628558943E+09 | 8.994192848E+08 | 1.767707087E+09 | −3.303256121E+08 | 4.549040985E+06 |
| A22 = | −5.281321669E+09 | −5.488998176E+09 | −6.060449802E+09 | 9.716445403E+08 | 6.910661183E+06 |
| A24 = | 1.109762530E+10 | 1.819917721E+10 | 1.371292184E+10 | −1.900393905E+09 | −6.886280688E+06 |
| A26 = | −1.362489044E+10 | −3.240787888E+10 | −1.845944993E+10 | 2.237881934E+09 | 4.042965874E+06 |
| A28 = | 7.415601175E+09 | 2.435063624E+10 | 1.121998763E+10 | −1.208799233E+09 | −1.058543863E+06 |
| Surface # | 9 | 10 | 11 | 12 | 13 |
| k = | 0.000000000E+00 | −5.358990000E+00 | −3.271230000E−02 | 0.000000000E+00 | −5.398140000E+01 |
| A4 = | −1.247837670E+00 | −4.366733903E−01 | −2.551150845E−01 | −1.669286686E+00 | −7.179492170E−01 |
| A6 = | 5.710404510E+00 | 1.085197708E+00 | 1.656962359E−01 | 5.395635609E+00 | 1.334074232E+00 |
| A8 = | −2.236999531E+01 | 1.372343614E+00 | 8.092217598E+00 | −9.891159499E+00 | −6.838994004E−01 |
| A10 = | −3.306856151E+01 | −2.622013804E+01 | −4.859081079E+01 | 1.261499107E+01 | −2.016876711E+00 |
| A12 = | 1.056074539E+03 | 9.533018299E+01 | 1.350443176E+02 | −1.115988873E+01 | 5.142941921E+00 |
| A14 = | −6.739411185E+03 | −2.104203012E+02 | −2.300376379E+02 | 6.558579896E+00 | −6.185849798E+00 |
| A16 = | 2.443172441E+04 | 3.319580432E+02 | 2.654790266E+02 | −2.309512781E+00 | 4.747766769E+00 |
| A18 = | −5.699101823E+04 | −3.810470204E+02 | −2.169696292E+02 | 2.761919689E−01 | −2.507044076E+00 |
| A20 = | 8.821138121E+04 | 3.134552078E+02 | 1.276748249E+02 | 1.553437579E−01 | 9.317908036E−01 |
| A22 = | −9.014870738E+04 | −1.811249542E+02 | −5.392835912E+01 | −9.392992547E−02 | −2.433062741E−01 |
| A24 = | 5.853489558E+04 | 7.148083943E+01 | 1.597969567E+01 | 2.492358965E−02 | 4.365232641E−02 |
| A26 = | −2.190652828E+04 | −1.832033206E+01 | −3.155590521E+00 | −3.769137449E−03 | −5.118412382E−03 |
| A28 = | 3.602459692E+03 | 2.747506980E+00 | 3.729166267E−01 | 3.151364015E−04 | 3.528253213E−04 |
| A30 = | | −1.830359104E−01 | −1.993982462E−02 | −1.137437010E−05 | −1.083250418E−05 |

In the 3rd embodiment, the equation of the aspheric surface profiles of the aforementioned lens elements is the same as the equation of the 1 st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
3rd Embodiment

| | | | |
|---|---|---|---|
| f [mm] | 2.44 | \|R10/R1\| | 2.13 |
| Fno | 2.47 | R10/R2 | 1.06 |
| HFOV [deg.] | 45.1 | ATmax/ATmin | 4.27 |
| FOV [deg.] | 90.2 | CTmax/CTmin | 2.09 |
| TL/ImgH | 1.07 | ΣCT/ΣAT | 1.00 |
| tan(HFOV) | 1.00 | TD/CT5 | 9.71 |
| TD/EPD | 2.31 | T34/CT2 | 1.85 |
| TL/BL | 6.72 | T45/T34 | 1.91 |
| TL/f5 | −1.42 | CT3/ET3 | 1.30 |
| TL/CT4 | 12.89 | tan(CRA) | 0.86 |
| f1/f5 | −1.41 | Vmin | 18.4 |
| f/f12 | 0.83 | V1/V2 | 3.05 |
| \|f/f3\| + \|f/f4\| | 0.66 | V2/V3 | 0.33 |
| \|f/R2\| − \|f/R4\| | 1.28 | SAG5R2/CT5 | −1.72 |
| R2/TD | 0.73 | 10 × SAG1R1/R1 | 2.08 |
| R7/f45 | −0.19 | SAG4R1/ET4 | −0.72 |
| \|R2/R1\| | 2.01 | Y5R1/Y2R1 | 4.14 |
| \|R9/R1\| | 2.99 | Y1R1/ImgH | 0.20 |

### 4th Embodiment

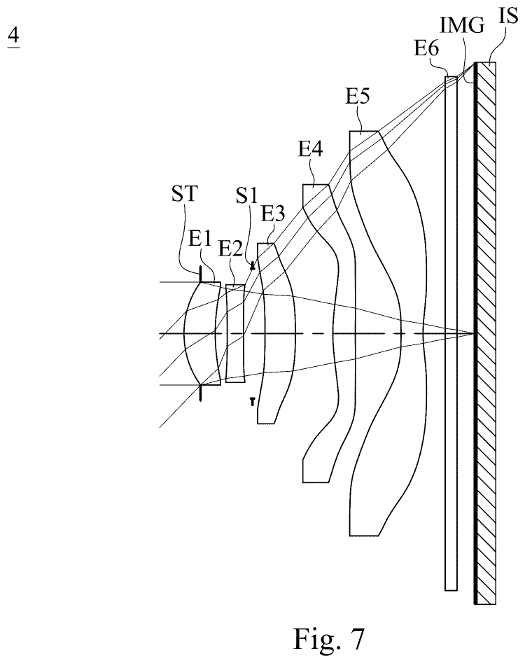

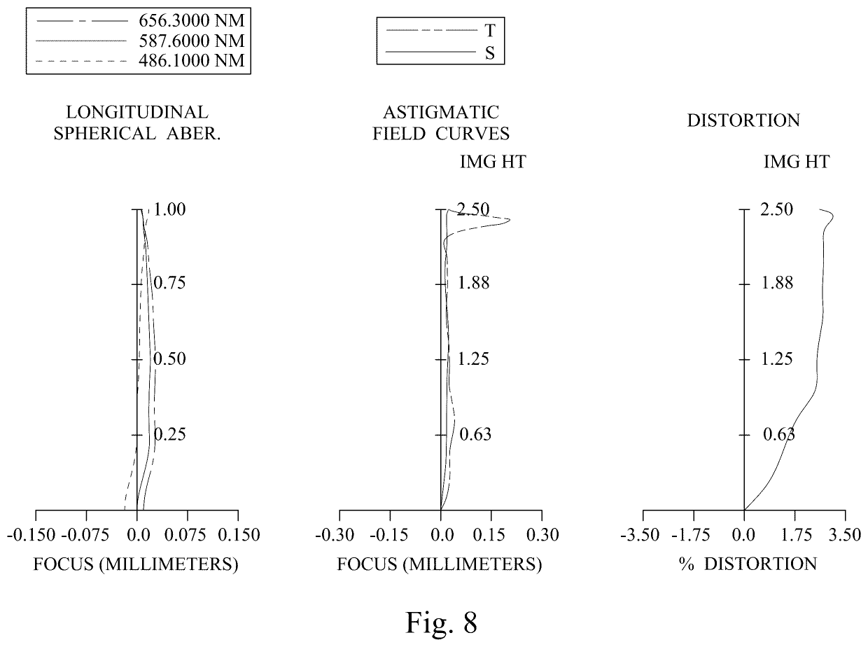

FIG. 7 is a schematic view of an imaging apparatus 4 according to the 4th embodiment of the present disclosure. FIG. 8 shows, in order from left to right, spherical aberration curves, astigmatic field curves and a distortion curve of the imaging apparatus according to the 4th embodiment. In FIG. 7, the imaging apparatus 4 according to the 4th embodiment includes an optical lens assembly (its reference number is omitted) and an image sensor IS. The optical lens assembly includes, in order from an object side to an image side along an optical path, an aperture stop ST, a first lens element E1, a second lens element E2, a stop S1, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, the image-side surface of the first lens element E1 includes one inflection point.

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric.

The third lens element E3 with positive refractive power has an object-side surface being concave in a paraxial region thereof and an image-side surface being convex in a paraxial region thereof. The third lens element E3 is made of glass material, and has the object-side surface and the image-side surface being both aspheric. Moreover, the object-side surface of the third lens element E3 includes two inflection points, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points and one critical point, the image-side surface of the fourth lens element E4 includes six inflection points and three critical points.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 4th embodiment are shown in Table 4A and the aspheric surface data are shown in Table 4B below.

TABLE 4A
4th Embodiment
f = 2.33 mm, Fno = 2.45, HFOV = 46.1 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.153 | | | | |
| 2 | Lens 1 | 0.8328 | ASP | 0.289 | Plastic | 1.544 | 56.0 | 2.60 |
| 3 | | 1.7728 | ASP | 0.111 | | | | |
| 4 | Lens 2 | −21.5066 | ASP | 0.150 | Plastic | 1.697 | 16.3 | −15.16 |
| 5 | | 20.8398 | ASP | 0.084 | | | | |
| 6 | Stop | Plano | | 0.115 | | | | |
| 7 | Lens 3 | −13.2165 | ASP | 0.281 | Glass | 1.541 | 47.2 | 13.32 |
| 8 | | −4.6975 | ASP | 0.346 | | | | |
| 9 | Lens 4 | 1.6215 | ASP | 0.207 | Plastic | 1.544 | 56.0 | 3.80 |
| 10 | | 7.2068 | ASP | 0.423 | | | | |
| 11 | Lens 5 | −8.9433 | ASP | 0.203 | Plastic | 1.515 | 56.4 | −1.94 |
| 12 | | 1.1314 | ASP | 0.205 | | | | |

| | | | | | | | |
|---|---|---|---|---|---|---|---|
| 13 | Filter | Plano | 0.110 | Glass | 1.517 | 64.2 | — |
| 14 | | Plano | 0.171 | | | | |
| 15 | Image | Plano | — | | | | |

Reference wavelength is 587.6 nm (d-line).
Effective radius of Surface 6 (Stop S1) is 0.600 mm.

TABLE 4B
Aspheric Coefficients

| | Surface # | | | | |
|---|---|---|---|---|---|
| | 2 | 3 | 4 | 5 | 7 |
| k= | −2.325120000E−01 | 2.529070000E+00 | 9.000000000E+01 | 6.517430000E+01 | −9.000000000E+01 |
| A4= | −1.086130688E−01 | −2.357358114E−01 | −4.979315380E−01 | −5.616618226E−02 | −8.695064066E−01 |
| A6= | 1.319656117E+01 | 8.757903472E+00 | 1.331288456E+01 | −7.379677410E+00 | 9.171223457E+00 |
| A8= | −4.528050137E+02 | −4.998137368E+02 | −6.771988792E+02 | 3.722247181E+02 | −1.504456370E+02 |
| A10= | 9.851754801E+03 | 1.767557777E+04 | 2.132299926E+04 | −9.495923240E+03 | 1.751806882E+03 |
| A12= | −1.400993678E+05 | −4.141682045E+05 | −4.343715684E+05 | 1.591316339E+05 | −1.403908256E+04 |
| A14= | 1.338410651E+06 | 6.584081841E+06 | 6.011762239E+06 | −1.827727292E+06 | 7.877680778E+04 |
| A16= | −8.656169847E+06 | −7.230328604E+07 | −5.796992775E+07 | 1.477319367E+07 | −3.111373270E+05 |
| A18= | 3.748959957E+07 | 5.529006206E+08 | 3.927910617E+08 | −8.480961416E+07 | 8.621899054E+05 |
| A20= | −1.049138548E+08 | −2.931082450E+09 | −1.858377176E+09 | 3.435792606E+08 | −1.642340207E+06 |
| A22= | 1.753089335E+08 | 1.054502859E+10 | 5.995091561E+09 | −9.580447344E+08 | 2.046133507E+06 |
| A24= | −1.458785024E+08 | −2.452935593E+10 | −1.253399296E+10 | 1.743410902E+09 | −1.498166655E+06 |
| A26= | 3.337973357E+07 | 3.323846448E+10 | 1.526872713E+10 | −1.854005476E+09 | 4.876909868E+05 |
| A28= | | −1.990204572E+10 | −8.206341294E+09 | 8.672684463E+08 | |
| | Surface # | | | | |
| | 8 | 9 | 10 | 11 | 12 |
| k= | 1.315930000E+01 | −1.928840000E+01 | 1.352460000E+01 | 1.285650000E+00 | −1.486880000E+01 |
| A4= | −1.110138115E+00 | −6.056271012E−01 | −9.044966499E−01 | −3.370101734E+00 | −1.593512705E+00 |
| A6= | 9.228755407E+00 | 5.571863131E+00 | 4.855889730E+00 | 1.454265641E+01 | 6.175761275E+00 |
| A8= | −1.045183330E+02 | −4.377705848E+01 | −1.712826610E+01 | −3.966162266E+01 | −1.482706627E+01 |
| A10= | 8.364630661E+02 | 2.690259798E+02 | 5.971270501E+01 | 7.496734574E+01 | 2.479514683E+01 |
| A12= | −4.565134297E+03 | −1.218177394E+03 | −1.904168735E+02 | −9.965584846E+01 | −3.072441922E+01 |
| A14= | 1.645977441E+04 | 3.893265121E+03 | 4.357206548E+02 | 9.474966358E+01 | 2.884316816E+01 |
| A16= | −3.517027115E+04 | −8.841914482E+03 | −6.805891203E+02 | −6.554130537E+01 | −2.052537631E+01 |
| A18= | 2.258091312E+04 | 1.434012731E+04 | 7.357497752E+02 | 3.337187512E+01 | 1.097274139E+01 |
| A20= | 1.044601220E+05 | −1.655006028E+04 | −5.576254520E+02 | −1.254495635E+01 | −4.344929021E+00 |
| A22= | −3.653124640E+05 | 1.342781738E+04 | 2.959437661E+02 | 3.452060904E+00 | 1.248365735E+00 |
| A24= | 5.789248936E+05 | −7.466618931E+03 | −1.078085185E+02 | −6.783392222E−01 | −2.519014013E−01 |
| A26= | −5.202125396E+05 | 2.705994771E+03 | 2.568732722E+01 | 9.039322563E−02 | 3.374553473E−02 |
| A28= | 2.556189026E+05 | −5.754624339E+02 | −3.604927252E+00 | −7.334798601E−03 | −2.689101738E−03 |
| A30= | −5.353568236E+04 | 5.446582881E+01 | 2.258552153E−01 | 2.739352769E−04 | 9.631842991E−05 |

In the 4th embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 4th embodiment, so an explanation in this regard will not be provided again.

Moreover, these parameters can be calculated from Table 4A and Table 4B as the following values and satisfy the following conditions:

TABLE 4C
4th Embodiment

| | | | |
|---|---|---|---|
| f [mm] | 2.33 | \|R10/R1\| | 1.36 |
| Fno | 2.45 | R10/R2 | 0.64 |
| HFOV [deg.] | 46.1 | ATmax/ATmin | 3.81 |
| FOV [deg.] | 92.2 | CTmax/CTmin | 1.93 |
| TL/ImgH | 1.08 | ΣCT/ΣAT | 1.05 |
| tan(HFOV) | 1.04 | TD/CT5 | 10.88 |
| TD/EPD | 2.32 | T34/CT2 | 2.31 |
| TL/BL | 5.54 | T45/T34 | 1.22 |
| TL/f5 | −1.39 | CT3/ET33 | 1.87 |
| TL/CT4 | 13.02 | tan(CRA) | 0.86 |
| f1/f5 | −1.35 | Vmin | 16.3 |
| f/f12 | 0.77 | V1/V2 | 3.44 |
| \|f/f3\| + \|f/f4\| | 0.79 | V2/V3 | 0.34 |
| \|f/R2\| − \|f/R4\| | 1.20 | SAG5R2/CT5 | −2.03 |
| R2/TD | 0.80 | 10 × SAG1R1/R1 | 1.90 |
| R7/f45 | −0.25 | SAG4R1/ET4 | −1.17 |
| \|R2/R1\| | 2.13 | Y5R1/Y2R1 | 4.03 |
| \|R9/R1\| | 10.74 | Y1R1/ImgH | 0.19 |

### 5th Embodiment

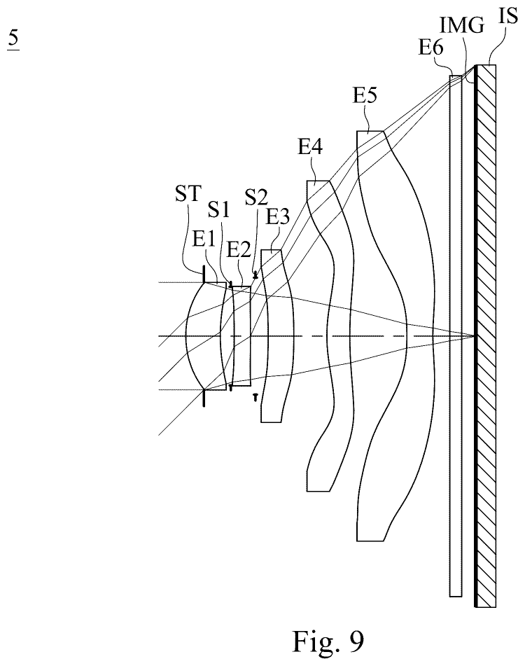

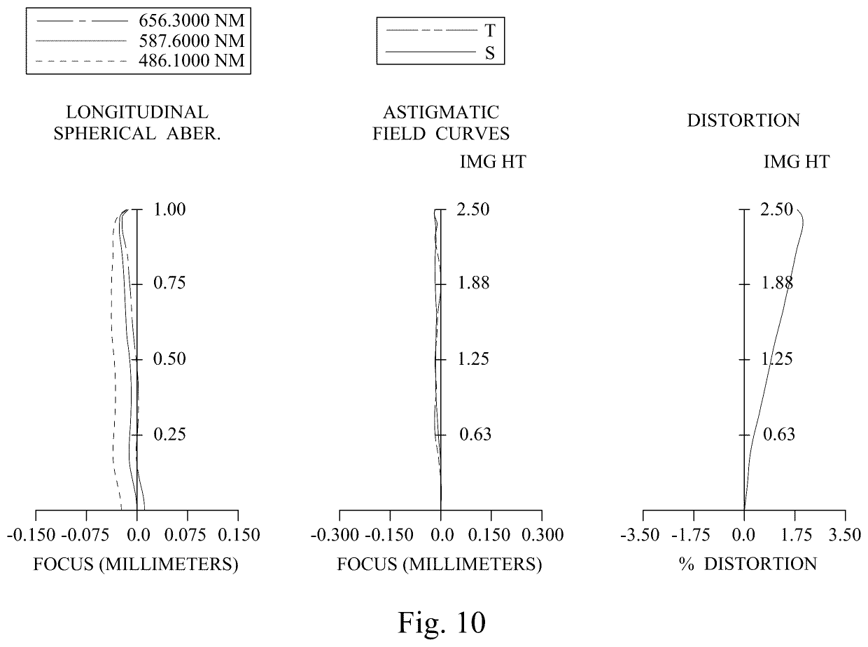

FIG. 9 is a schematic view of an imaging apparatus 5 according to the 5th embodiment of the present disclosure. FIG. 10 shows, in order from left to right, spherical aberration curves, astigmatic field curves and a distortion curve of the imaging apparatus according to the 5th embodiment. In FIG. 9, the imaging apparatus 5 according to the 5th embodiment includes an optical lens assembly (its reference number is omitted) and an image sensor IS. The optical lens assembly includes, in order from an object side to an image side along an optical path, an aperture stop ST, a first lens element E1, a stop S1, a second lens element E2, a stop S2, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, the image-side surface of the first lens element E1 includes one inflection point.

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric. Moreover, the image-side surface of the second lens element E2 includes two inflection points and two critical points.

The third lens element E3 with positive refractive power has an object-side surface being concave in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes two inflection points, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points and one critical point, the image-side surface of the fourth lens element E4 includes one inflection point and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 5th embodiment are shown in Table 5A and the aspheric surface data are shown in Table 5B below.

TABLE 5A
5th Embodiment
f = 2.46 mm, Fno = 2.48, HFOV = 45.1 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.168 | | | | |
| 2 | Lens 1 | 0.8215 | ASP | 0.319 | Plastic | 1.545 | 56.1 | 2.57 |
| 3 | | 1.7176 | ASP | 0.097 | | | | |
| 4 | Stop | Plano | | 0.031 | | | | |
| 5 | Lens 2 | −16.4020 | ASP | 0.150 | Plastic | 1.686 | 18.4 | −20.50 |
| 6 | | 99.0099 | ASP | 0.047 | | | | |
| 7 | Stop | Plano | | 0.117 | | | | |
| 8 | Lens 3 | −10.4787 | ASP | 0.237 | Plastic | 1.544 | 56.0 | 63.18 |
| 9 | | −8.0945 | ASP | 0.306 | | | | |
| 10 | Lens 4 | 1.3931 | ASP | 0.212 | Plastic | 1.544 | 56.0 | 4.23 |
| 11 | | 3.3357 | ASP | 0.527 | | | | |
| 12 | Lens 5 | −2.3788 | ASP | 0.240 | Plastic | 1.534 | 55.9 | −1.92 |
| 13 | | 1.8695 | ASP | 0.157 | | | | |

| | | | | | | | |
|---|---|---|---|---|---|---|---|
| 14 | Filter | Plano | 0.110 | Glass | 1.517 | 64.2 | — |
| 15 | | Plano | 0.130 | | | | |
| 16 | Image | Plano | — | | | | |

Reference wavelength is 587.6 nm (d-line).
Effective radius of Surface 4 (Stop S1) is 0.455 mm.
Effective radius of Surface 7 (Stop S1) is 0.540 mm.

TABLE 5B
Aspheric Coefficients

| | Surface # | | | | |
|---|---|---|---|---|---|
| | 2 | 3 | 5 | 6 | 8 |
| k= | −1.278790000E−01 | 3.815040000E+00 | 0.000000000E+00 | 0.000000000E+00 | 0.000000000E+00 |
| A4= | 5.278873108E−02 | −2.445995707E−01 | −1.005734643E−01 | −5.923137539E−01 | 1.041320443E+00 |
| A6= | −5.599582782E+00 | 1.593621819E+01 | −1.376350741E+01 | 2.231200693E+01 | 8.491681299E+00 |
| A8= | 4.567168974E+02 | −9.161463378E+02 | 3.823666761E+02 | −8.213279879E+02 | −1.116725771E+02 |
| A10= | −1.598629171E+04 | 3.109820213E+04 | −4.085028207E+03 | 2.065993576E+04 | 1.231751268E+03 |
| A12= | 3.333325309E+05 | −6.835633226E+05 | −5.561184203E+04 | −3.506937219E+05 | −1.020335885E+04 |
| A14= | −4.544566826E+06 | 1.011832258E+07 | 2.599207207E+06 | 4.147362745E+06 | 6.323333960E+04 |
| A16= | 4.225649734E+07 | −1.032487599E+08 | −4.280767188E+07 | −3.479550508E+07 | −2.900084771E+05 |
| A18= | −2.726191931E+08 | 7.333342108E+08 | 4.150610515E+08 | 2.086042537E+08 | 9.785629655E+05 |
| A20= | 1.219021346E+09 | −3.609835022E+09 | −2.594265885E+09 | −8.890091263E+08 | −2.396300216E+06 |
| A22= | −3.701417366E+09 | 1.204783674E+10 | 1.058555484E+10 | 2.635412386E+09 | 4.121008620E+06 |
| A24= | 7.267745564E+09 | −2.594197693E+10 | −2.728111960E+10 | −5.177024163E+09 | −4.681316341E+06 |
| A26= | −8.302473931E+09 | 3.240729954E+10 | 4.032335042E+10 | 6.071309180E+09 | 3.128879276E+06 |
| A28= | 4.176538387E+09 | −1.776832776E+10 | −2.603693004E+10 | −3.223762506E+09 | −9.253207835E+05 |
| | Surface # | | | | |
| | 9 | 10 | 11 | 12 | 13 |
| k= | 0.000000000E+00 | −8.064080000E+00 | −4.943410000E−01 | 0.000000000E+00 | −3.653740000E+01 |
| A4= | −1.077160822E+00 | −4.688033354E−01 | −4.464119802E−01 | −1.790352463E+00 | 1.067392980E+00 |
| A6= | 3.575719127E+00 | 1.747108973E+00 | 2.094210167E+00 | 7.134106865E+00 | 3.739917838E+00 |
| A8= | −1.198785659E+00 | −3.268026686E+00 | −5.378397916E+00 | −1.900218621E+01 | −9.083795821E+00 |
| A10= | −1.888384856E+02 | −1.734708862E+01 | 3.992942817E+00 | 3.729240035E+01 | 1.575102051E+01 |
| A12= | 1.955148063E+03 | 1.235649109E+02 | 1.075349340E+01 | −5.242086232E+01 | −1.986028976E+01 |
| A14= | −1.072983461E+04 | −3.938544631E+02 | −3.831619472E+01 | 5.281969720E+01 | 1.841721655E+01 |
| A16= | 3.754862918E+04 | 7.813540298E+02 | 6.383386902E+01 | −3.859049692E+01 | −1.263787438E+01 |
| A18= | −8.734216674E+04 | −1.034297523E+03 | −6.943869604E+01 | 2.059993742E+01 | 6.419622787E+00 |
| A20= | 1.352193618E+05 | 9.376650825E+02 | 5.257335888E+01 | −8.025809143E+00 | −2.398168700E+00 |
| A22= | −1.360797972E+05 | −5.854772156E+02 | −2.789049838E+01 | 2.254253952E+00 | 6.484202941E−01 |
| A24= | 8.403363152E+04 | 2.481220987E+02 | 1.015563004E+01 | −4.439050457E−01 | −1.231245365E−01 |
| A26= | −2.803550710E+04 | −6.830350942E+01 | −2.414850695E+00 | 5.806953604E−02 | 1.553832387E−02 |
| A28= | 3.607707561E+03 | 1.103697143E+01 | 3.373712771E−01 | −4.525702877E−03 | −1.168256345E−03 |
| A30= | | −7.957038468E−01 | −2.098556357E−02 | 1.587881236E−04 | 3.954668953E−05 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
5th Embodiment

| | | | |
|---|---|---|---|
| f [mm] | 2.46 | \|R10/R1\| | 2.28 |
| Fno | 2.48 | R10/R2 | 1.09 |
| HFOV [deg.] | 45.1 | ATmax/ATmin | 4.12 |
| FOV [deg.] | 90.2 | CTmax/CTmin | 2.13 |
| TL/ImgH | 1.07 | ΣCT/ΣAT | 1.03 |
| tan(HFOV) | 1.00 | TD/CT5 | 9.51 |
| TD/EPD | 2.30 | T34/CT2 | 2.04 |
| TL/BL | 6.75 | T45/T34 | 1.72 |
| TL/f5 | −1.39 | CT3/ET3 | 1.29 |
| TL/CT4 | 12.64 | tan(CRA) | 0.87 |
| f1/f5 | −1.33 | Vmin | 18.4 |
| f/f12 | 0.86 | V1/V2 | 3.05 |
| \|f/f3\| + \|f/f4\| | 0.62 | V2/V3 | 0.33 |
| \|f/R2\| − \|f/R4\| | 1.41 | SAG5R2/CT5 | −1.90 |
| R2/TD | 0.75 | 10 × SAG1R1/R1 | 2.13 |
| R7/f45 | −0.25 | SAG4R1/ET4 | −0.89 |
| \|R2/R1\| | 2.09 | Y5R1/Y2R1 | 4.02 |
| \|R9/R1\| | 2.90 | Y1R1/ImgH | 0.20 |

### 6th Embodiment

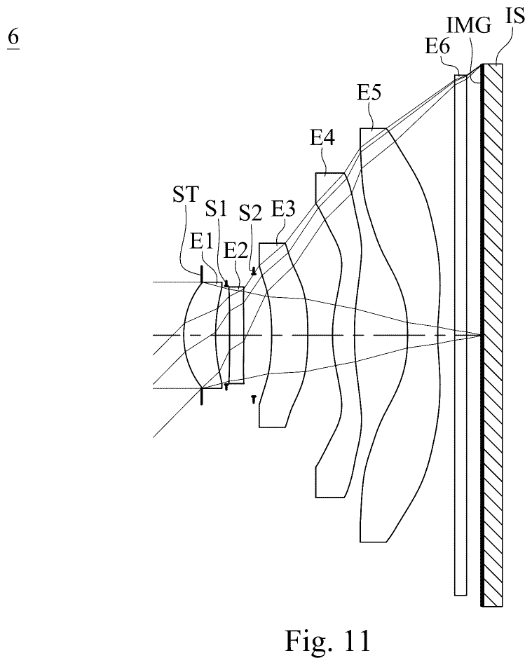

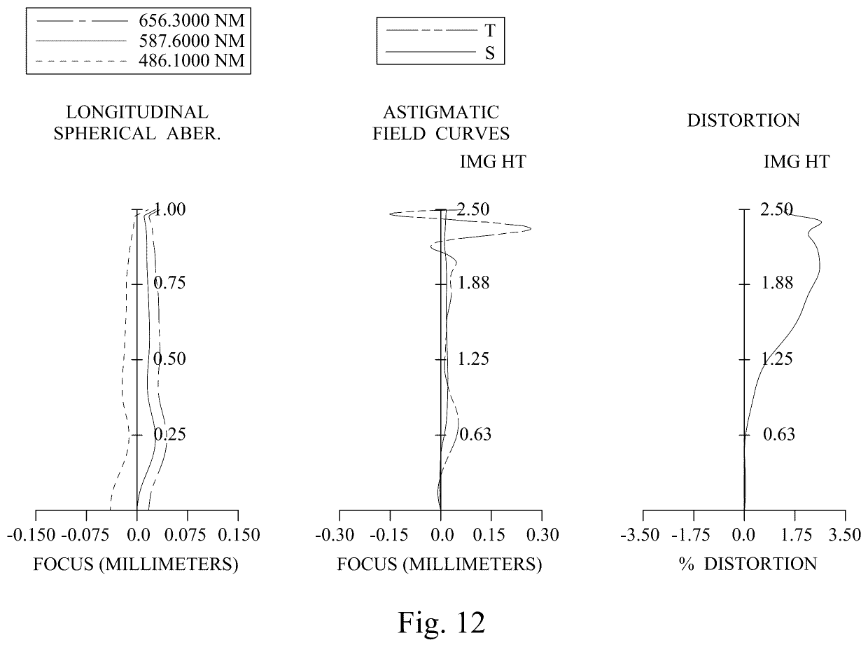

FIG. 11 is a schematic view of an imaging apparatus 6 according to the 6th embodiment of the present disclosure. FIG. 12 shows, in order from left to right, spherical aberration curves, astigmatic field curves and a distortion curve of the imaging apparatus according to the 6th embodiment. In FIG. 11, the imaging apparatus 6 according to the 6th embodiment includes an optical lens assembly (its reference number is omitted) and an image sensor IS. The optical lens assembly includes, in order from an object side to an image side along an optical path, an aperture stop ST, a first lens element E1, a stop S1, a second lens element E2, a stop S2, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, the image-side surface of the first lens element E1 includes one inflection point.

The second lens element E2 with positive refractive power has an object-side surface being convex in a paraxial region thereof and an image-side surface being convex in a paraxial region thereof. The second lens element E2 is made of plastic material, and has the object-side surface and the image-side surface being both aspheric. Moreover, the object-side surface of the second lens element E2 includes one inflection point and one critical point, the image-side surface of the second lens element E2 includes one inflection point and one critical point.

The third lens element E3 with negative refractive power has an object-side surface being concave in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes three inflection points and one critical point, the image-side surface of the fourth lens element E4 includes three inflection points and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes three inflection points and one critical point.

The filter E6 is made of glass material and disposed between the fifth lens element E5 and the image surface MG and will not affect a focal length of the optical lens assembly.

The detailed optical data of the 6th embodiment are shown in Table 6A and the aspheric surface data are shown in Table 6B below.

TABLE 6A
6th Embodiment
f = 2.42 mm, Fno = 2.47, HFOV = 45.4 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.165 | | | | |
| 2 | Lens 1 | 0.7991 | ASP | 0.294 | Plastic | 1.511 | 56.8 | 2.77 |
| 3 | | 1.6071 | ASP | 0.100 | | | | |
| 4 | Stop | Plano | | 0.029 | | | | |
| 5 | Lens 2 | 24.8796 | ASP | 0.131 | Plastic | 1.697 | 16.3 | 16.18 |
| 6 | | −20.5832 | ASP | 0.092 | | | | |
| 7 | Stop | Plano | | 0.166 | | | | |
| 8 | Lens 3 | −2.6441 | ASP | 0.333 | Plastic | 1.562 | 44.6 | −12.05 |
| 9 | | −4.5355 | ASP | 0.228 | | | | |
| 10 | Lens 4 | 1.2219 | ASP | 0.203 | Plastic | 1.614 | 26.0 | 3.46 |
| 11 | | 2.6976 | ASP | 0.490 | | | | |
| 12 | Lens 5 | −2.3524 | ASP | 0.278 | Plastic | 1.562 | 44.6 | −1.76 |
| 13 | | 1.7703 | ASP | 0.157 | | | | |

| | | | | | | | |
|---|---|---|---|---|---|---|---|
| 14 | Filter | Plano | 0.110 | Glass | 1.517 | 64.2 | — |
| 15 | | Plano | 0.144 | | | | |
| 16 | Image | Plano | — | | | | |

Reference wavelength is 587.6 nm (d-line).
Effective radius of Surface 4 (Stop S1) is 0.455 mm.
Effective radius of Surface 7 (Stop S1) is 0.565 mm.

TABLE 6B
Aspheric Coefficients

| | Surface # | | | | |
|---|---|---|---|---|---|
| | 2 | 3 | 5 | 6 | 8 |
| k= | −3.306740000E−01 | 1.764510000E+00 | 9.000000000E+01 | −9.000000000E+01 | −1.856730000E+01 |
| A4= | 3.824652375E−01 | −8.961103747E−02 | −9.261687121E−01 | 5.361775643E−01 | −3.717510947E−01 |
| A6= | −1.984261509E+01 | 4.662674427E+00 | 3.915863321E+01 | −4.747539348E+01 | −1.294779759E+01 |
| A8= | 9.510177184E+02 | −3.274226806E+02 | −1.542619774E+03 | 1.820680018E+03 | 3.180047800E+02 |
| A10= | −2.852604794E+04 | 1.294245464E+04 | 3.918932011E+04 | −4.311054714E+04 | −4.530019081E+03 |
| A12= | 5.699047332E+05 | −3.319887556E+05 | −6.675951452E+05 | 6.815171278E+05 | 4.253150906E+04 |
| A14= | −7.834495274E+06 | 5.764132157E+06 | 7.833408492E+06 | −7.416152019E+06 | −2.754424687E+05 |
| A16= | 7.558078851E+07 | −6.951208286E+07 | −6.395287258E+07 | 5.638635289E+07 | 1.263395306E+06 |
| A18= | −5.153797000E+08 | 5.881977192E+08 | 3.615988612E+08 | −2.991302570E+08 | −4.146885300E+06 |
| A20= | 2.469027992E+09 | −3.477256662E+09 | −1.384716166E+09 | 1.085353524E+09 | 9.709180641E+06 |
| A22= | −8.121137906E+09 | 1.405068633E+10 | 3.416790617E+09 | −2.567469161E+09 | −1.590053160E+07 |
| A24= | 1.744576904E+10 | −3.694598306E+10 | −4.885440082E+09 | 3.567787718E+09 | 1.738528707E+07 |
| A26= | −2.201979960E+10 | 5.691504656E+10 | 3.063210865E+09 | −2.208960842E+09 | −1.144712987E+07 |
| A28= | 1.237084561E+10 | −3.893781230E+10 | | | 3.442971808E+06 |
| | Surface # | | | | |
| | 9 | 10 | 11 | 12 | 13 |
| k= | 7.654010000E+00 | −6.208560000E+00 | 1.783730000E−01 | −2.525450000E−01 | −4.377410000E+01 |
| A4= | −1.514680422E+00 | −6.142989379E−01 | −3.780182692E−01 | −1.755581111E+00 | −7.288068567E−01 |
| A6= | 1.484321705E+01 | 4.589968667E+00 | 3.253746400E+00 | 8.667765818E+00 | 2.229522614E+00 |
| A8= | −1.807387246E+02 | −2.592006243E+01 | −1.734150831E+01 | −3.052427585E+01 | −5.089739305E+00 |
| A10= | 1.565318237E+03 | 8.652786005E+01 | 5.551882645E+01 | 7.441727046E+01 | 8.356885949E+00 |
| A12= | −9.377755556E+03 | −1.852416517E+02 | −1.234332755E+02 | −1.209777860E+02 | −1.007580958E+01 |
| A14= | 3.964436348E+04 | 2.308683925E+02 | 1.999168087E+02 | 1.341243808E+02 | 9.184741180E+00 |
| A16= | −1.196891148E+05 | −7.507142473E+01 | −2.393355420E+02 | −1.043519303E+02 | −6.396961388E+00 |
| A18= | 2.587446093E+05 | −2.799274442E+02 | 2.117960033E+02 | 5.807383220E+01 | 3.376965333E+00 |
| A20= | −3.966587037E+05 | 5.841872968E+02 | −1.372602941E+02 | −2.327665886E+01 | −1.327034780E+00 |
| A22= | 4.201248574E+05 | −5.984272148E+02 | 6.397222826E+01 | 6.674224847E+00 | 3.787491791E−01 |
| A24= | −2.918230895E+05 | 3.753406567E+02 | −2.078662312E+01 | −1.336699003E+00 | −7.581441619E−02 |
| A26= | 1.194586618E+05 | −1.457631845E+02 | 4.457732393E+00 | 1.776894352E−01 | 1.005245236E−02 |
| A28= | −2.182554221E+04 | 3.227101396E+01 | −5.661260990E−01 | −1.408972997E−02 | −7.910840210E−04 |
| A30= | | −3.119401760E+00 | 3.221726513E−02 | 5.043762208E−04 | 2.793057731E−05 |

In the 6th embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 6th embodiment, so an explanation in this regard will not be provided again.

Moreover, these parameters can be calculated from Table 6A and Table 6B as the following values and satisfy the following conditions:

TABLE 6C
6th Embodiment

| | | | |
|---|---|---|---|
| f [mm] | 2.42 | \|R10/R1\| | 2.22 |
| Fno | 2.47 | R10/R2 | 1.10 |
| HFOV [deg.] | 45.4 | ATmax/ATmin | 3.80 |
| FOV [deg.] | 90.8 | CTmax/CTmin | 2.54 |
| TL/ImgH | 1.10 | ΣCT/ΣAT | 1.12 |
| tan(HFOV) | 1.01 | TD/CT5 | 8.43 |
| TD/EPD | 2.39 | T34/CT2 | 1.74 |
| TL/BL | 6.70 | T45/T34 | 2.15 |
| TL/f5 | −1.57 | CT3/ET3 | 1.39 |
| TL/CT4 | 13.57 | tan(CRA) | 0.76 |
| f1/f5 | −1.58 | Vmin | 16.3 |
| f/f12 | 1.00 | V1/V2 | 3.49 |
| \|f/f3\| + \|f/f4\| | 0.90 | V2/V3 | 0.36 |
| \|f/R2\| − \|f/R4\| | 1.39 | SAG5R2/CT5 | −1.71 |
| R2/TD | 0.69 | 10 × SAG1R1/R1 | 2.19 |
| R7/f45 | −0.18 | SAG4R1/ET4 | −0.59 |
| \|R2/R1\| | 2.01 | Y5R1/Y2R1 | 4.00 |
| \|R9/R1\| | 2.94 | Y1R1/ImgH | 0.20 |

### 7th Embodiment

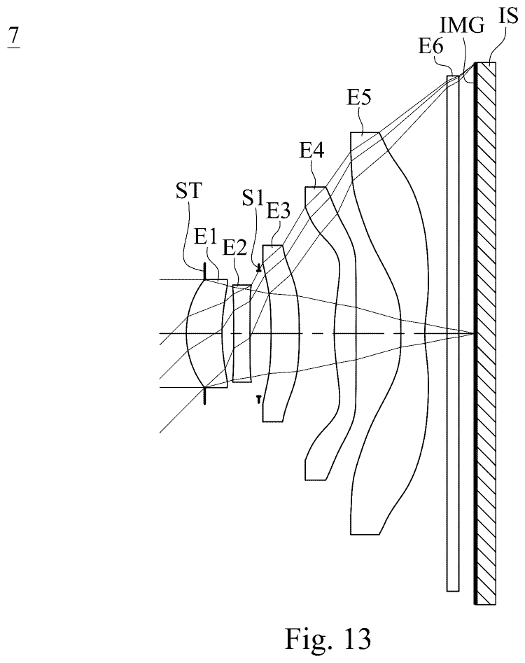

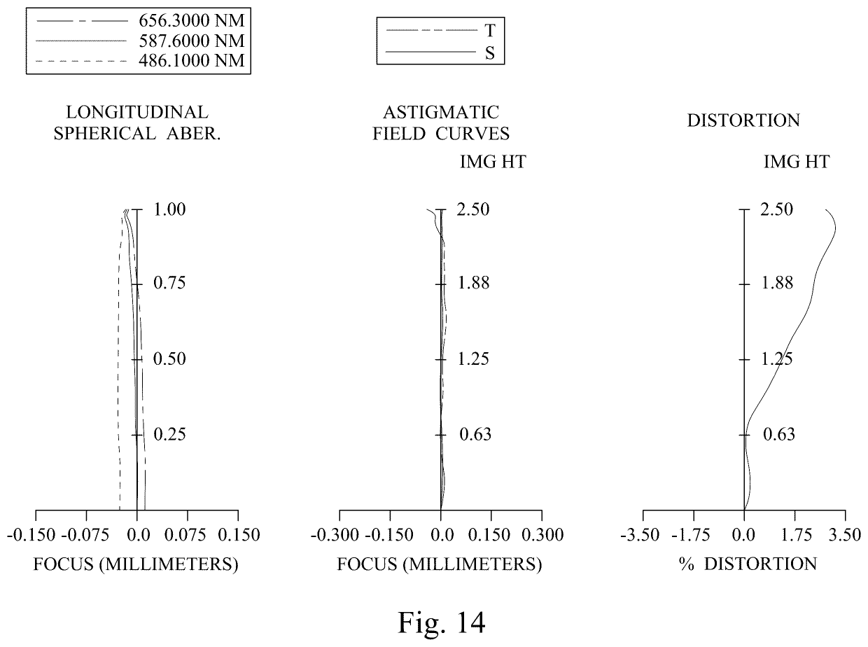

FIG. 13 is a schematic view of an imaging apparatus 7 according to the 7th embodiment of the present disclosure. FIG. 14 shows, in order from left to right, spherical aberration curves, astigmatic field curves and a distortion curve of the imaging apparatus according to the 7th embodiment. In FIG. 13, the imaging apparatus 7 according to the 7th embodiment includes an optical lens assembly (its reference number is omitted) and an image sensor IS. The optical lens assembly includes, in order from an object side to an image side along an optical path, an aperture stop ST, a first lens element E1, a second lens element E2, a stop S1, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes one inflection point and one critical point.

The third lens element E3 with positive refractive power has an object-side surface being concave in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes three inflection points, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points and one critical point, the image-side surface of the fourth lens element E4 includes five inflection points and three critical points.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 7th embodiment are shown in Table 7A and the aspheric surface data are shown in Table 7B below.

TABLE 7A
7th Embodiment
f = 2.43 mm, Fno = 2.43, HFOV = 45.2 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.170 | | | | |
| 2 | Lens 1 | 0.8347 | ASP | 0.330 | Plastic | 1.545 | 56.1 | 2.59 |
| 3 | | 1.7547 | ASP | 0.108 | | | | |
| 4 | Lens 2 | 168.8234 | ASP | 0.150 | Plastic | 1.686 | 18.4 | −31.37 |
| 5 | | 19.0843 | ASP | 0.082 | | | | |
| 6 | Stop | Plano | | 0.113 | | | | |
| 7 | Lens 3 | −8.0841 | ASP | 0.261 | Plastic | 1.544 | 56.0 | 48.70 |
| 8 | | −6.2647 | ASP | 0.323 | | | | |
| 9 | Lens 4 | 1.6515 | ASP | 0.201 | Plastic | 1.562 | 44.6 | 3.70 |
| 10 | | 7.6682 | ASP | 0.415 | | | | |
| 11 | Lens 5 | −9.5943 | ASP | 0.221 | Plastic | 1.534 | 55.9 | −1.74 |
| 12 | | 1.0375 | ASP | 0.205 | | | | |

| | | | | | | | |
|---|---|---|---|---|---|---|---|
| 13 | Filter | Plano | 0.110 | Glass | 1.517 | 64.2 | — |
| 14 | | Plano | 0.155 | | | | |
| 15 | Image | Plano | — | | | | |

Reference wavelength is 587.6 nm (d-line).
Effective radius of Surface 6 (Stop S1) is 0.580 mm.

TABLE 7B
Aspheric Coefficients

| | Surface # | | | | |
|---|---|---|---|---|---|
| | 2 | 3 | 4 | 5 | 7 |
| k= | −2.033460000E−01 | 1.945960000E+00 | 0.000000000E+00 | 0.000000000E+00 | 0.000000000E+00 |
| A4= | −6.257401468E−02 | −2.790464006E−01 | −2.579876851E−01 | −1.583380741E−01 | −8.280810101E−01 |
| A6= | 6.893037647E+00 | 1.509721121E+01 | 6.013787959E+00 | −4.785921347E+00 | 6.933110077E+00 |
| A8= | −2.294778365E+02 | −8.065487017E+02 | −6.348060290E+02 | 4.323096098E+02 | −1.169748299E+02 |
| A10= | 5.547683337E+03 | 2.522012257E+04 | 2.619332813E+04 | −1.465829936E+04 | 1.534566737E+03 |
| A12= | −9.259713653E+04 | −5.132306926E+05 | −6.172659115E+05 | 2.963831346E+05 | −1.420650101E+04 |
| A14= | 1.055817272E+06 | 7.092896814E+06 | 9.307762726E+06 | −3.910231200E+06 | 9.208032617E+04 |
| A16= | −8.210434815E+06 | −6.817394658E+07 | −9.431956939E+07 | 3.518319099E+07 | −4.163074815E+05 |
| A18= | 4.329214315E+07 | 4.596024841E+08 | 6.560408029E+08 | −2.197984315E+08 | 1.305146685E+06 |
| A20= | −1.517096135E+08 | −2.160929362E+09 | −3.137499254E+09 | 9.526794636E+08 | −2.776429117E+06 |
| A22= | 3.371706011E+08 | 6.925487713E+09 | 1.013156232E+10 | −2.807830799E+09 | 3.812675390E+06 |
| A24= | −4.286102483E+08 | −1.439262110E+10 | −2.108228358E+10 | 5.361964550E+09 | −3.039561132E+06 |
| A26= | 2.364034755E+08 | 1.745175818E+10 | 2.549102462E+10 | −5.974663509E+09 | 1.065838226E+06 |
| A28= | | −9.355551947E+09 | −1.359133756E+10 | 2.944455682E+09 | |
| | Surface # | | | | |
| | 8 | 9 | 10 | 11 | 12 |
| k= | 0.000000000E+00 | −2.020270000E+01 | 1.081500000E+01 | 0.000000000E+00 | −1.652370000E+01 |
| A4= | −1.030007938E+00 | −5.336387980E−01 | −9.347891990E−01 | −3.363741951E+00 | −1.558668032E+00 |
| A6= | 5.041579071E+00 | 3.319332078E+00 | 4.597574859E+00 | 1.420796620E+01 | 5.822512716E+00 |
| A8= | −2.880729355E+01 | −1.457723024E+01 | −8.960981280E+00 | −3.713031565E+01 | −1.366192323E+01 |
| A10= | 8.722741632E+01 | 6.332365583E+01 | −1.960206153E+00 | 6.624534795E+01 | 2.226120508E+01 |
| A12= | 1.910345086E+01 | −3.162573483E+02 | 5.281117056E+01 | −8.194281756E+01 | −2.650960462E+01 |
| A14= | −1.188656395E+03 | 1.238737909E+03 | −1.620876780E+02 | 7.114902239E+01 | 2.358639470E+01 |
| A16= | 4.624506776E+03 | −3.361871044E+03 | 3.066531070E+02 | −4.376376015E+01 | −1.579393447E+01 |
| A18= | −8.845920579E+03 | 6.219064776E+03 | −4.002159690E+02 | 1.907635116E+01 | 7.950894579E+00 |
| A20= | 8.880573527E+03 | −7.850424372E+03 | 3.662416917E+02 | −5.810513008E+00 | −2.984657888E+00 |
| A22= | −3.774177722E+03 | 6.745484306E+03 | −2.336084045E+02 | 1.190467219E+00 | 8.211178309E−01 |
| A24= | −3.524512918E+02 | −3.879843509E+03 | 1.015523049E+02 | −1.499208606E−01 | −1.604137318E−01 |
| A26= | 5.773122102E+02 | 1.429855372E+03 | −2.865464091E+01 | 8.793971392E−03 | 2.102613979E−02 |
| A28= | | −3.053819091E+02 | 4.728402158E+00 | 1.485966028E−04 | −1.654580084E−03 |
| A30= | | 2.876017318E+01 | −3.461834885E−01 | −3.455922582E−05 | 5.896705805E−05 |

In the 7th embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 7th embodiment, so an explanation in this regard will not be provided again.

Moreover, these parameters can be calculated from Table 7A and Table 7B as the following values and satisfy the following conditions:

TABLE 7C
7th Embodiment

| | | | |
|---|---|---|---|
| f [mm] | 2.43 | \|R10/R1\| | 1.24 |
| Fno | 2.43 | R10/R2 | 0.59 |
| HFOV [deg.] | 45.2 | ATmax/ATmin | 3.84 |
| FOV [deg.] | 90.4 | CTmax/CTmin | 2.20 |
| TL/ImgH | 1.07 | ΣCT/ΣAT | 1.12 |
| tan(HFOV) | 1.01 | TD/CT5 | 9.97 |
| TD/EPD | 2.21 | T34/CT2 | 2.15 |
| TL/BL | 5.69 | T45/T34 | 1.28 |
| TL/f5 | −1.54 | CT3/ET3 | 1.44 |
| TL/CT4 | 13.30 | tan(CRA) | 0.86 |
| f1/f5 | −1.49 | Vmin | 18.4 |
| f/f12 | 0.87 | V1/V2 | 3.05 |
| \|f/f3\| + \|f/f4\| | 0.71 | V2/V3 | 0.33 |
| \|f/R2\| − \|f/R4\| | 1.26 | SAG5R2/CT5 | −1.91 |
| R2/TD | 0.80 | 10 × SAG1R1/R1 | 2.03 |
| R7/f45 | −0.32 | SAG4R1/ET4 | −1.42 |
| \|R2/R1\| | 2.10 | Y5R1/Y2R1 | 3.89 |
| \|R9/R1\| | 11.49 | Y1R1/ImgH | 0.20 |

### 8th Embodiment

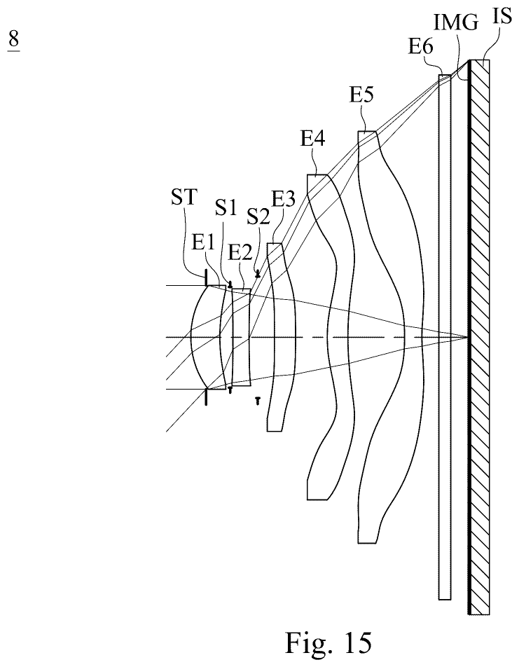

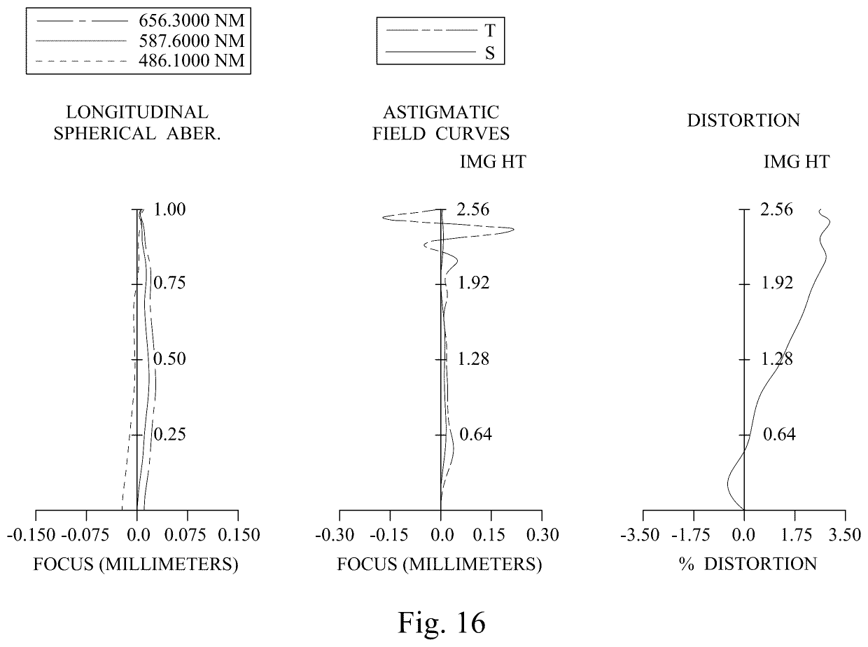

FIG. 15 is a schematic view of an imaging apparatus 8 according to the 8th embodiment of the present disclosure. FIG. 16 shows, in order from left to right, spherical aberration curves, astigmatic field curves and a distortion curve of the imaging apparatus according to the 8th embodiment. In FIG. 15, the imaging apparatus 8 according to the 8th embodiment includes an optical lens assembly (its reference number is omitted) and an image sensor IS. The optical lens assembly includes, in order from an object side to an image side along an optical path, an aperture stop ST, a first lens element E1, a stop S1, a second lens element E2, a stop S2, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points and one critical point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes three inflection points and one critical point, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes three inflection points and one critical point, the image-side surface of the fourth lens element E4 includes three inflection points and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes four inflection points and two critical points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 8th embodiment are shown in Table 8A and the aspheric surface data are shown in Table 8B below.

TABLE 8A
8th Embodiment
f = 2.33 mm, Fno = 2.43, HFOV = 46.9 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.141 | | | | |
| 2 | Lens 1 | 0.8063 | ASP | 0.268 | Plastic | 1.544 | 56.0 | 2.62 |
| 3 | | 1.6399 | ASP | 0.095 | | | | |
| 4 | Stop | Plano | | 0.025 | | | | |
| 5 | Lens 2 | 41.3637 | ASP | 0.150 | Plastic | 1.697 | 16.3 | −17.63 |
| 6 | | 9.4636 | ASP | 0.080 | | | | |
| 7 | Stop | Plano | | 0.154 | | | | |
| 8 | Lens 3 | 20.7378 | ASP | 0.195 | Plastic | 1.567 | 37.4 | 31.10 |
| 9 | | −116.8365 | ASP | 0.293 | | | | |
| 10 | Lens 4 | 1.2256 | ASP | 0.191 | Plastic | 1.562 | 44.6 | 3.51 |
| 11 | | 3.0573 | ASP | 0.523 | | | | |
| 12 | Lens 5 | −2.4194 | ASP | 0.160 | Plastic | 1.511 | 56.8 | −1.83 |
| 13 | | 1.5572 | ASP | 0.157 | | | | |

| | | | | | | | |
|---|---|---|---|---|---|---|---|
| 14 | Filter | Plano | 0.110 | Glass | 1.517 | 64.2 | — |
| 15 | | Plano | 0.171 | | | | |
| 16 | Image | Plano | — | | | | |

Reference wavelength is 587.6 nm (d-line).
Effective radius of Surface 4 (Stop S1) is 0.465 mm.
Effective radius of Surface 7 (Stop S2) is 0.560 mm.

TABLE 8B
Aspheric Coefficients

| | Surface # | | | | |
|---|---|---|---|---|---|
| | 2 | 3 | 5 | 6 | 8 |
| k= | −2.681740000E−01 | 2.158210000E+00 | 2.466740000E+01 | 9.000000000E+01 | −7.182680000E+01 |
| A4= | −2.652521190E−01 | −2.120428463E−01 | −2.754430926E−01 | −3.519509824E−01 | −9.694381165E−01 |
| A6= | 2.765875553E+01 | 8.532520982E+00 | −9.542826144E+00 | 1.181709341E+01 | 7.546801884E+00 |
| A8= | −1.160324769E+03 | −3.256688376E+02 | 4.933452106E+02 | −4.355975520E+02 | −9.345748175E+01 |
| A10= | 3.135098087E+04 | 5.824186901E+03 | −1.603631562E+04 | 1.137661315E+04 | 9.944058037E+02 |
| A12= | −5.713157705E+05 | −2.959286438E+04 | 3.570022685E+05 | −2.016962418E+05 | −7.946411415E+03 |
| A14= | 7.267839248E+06 | −8.622769441E+05 | −5.548478152E+06 | 2.522986947E+06 | 4.605614391E+04 |
| A16= | −6.572414526E+07 | 2.115525264E+07 | 6.064853538E+07 | −2.270579168E+07 | −1.917686563E+05 |
| A18= | 4.248080980E+08 | −2.347913182E+08 | −4.665345961E+08 | 1.479721495E+08 | 5.728545079E+05 |
| A20= | −1.948313436E+09 | 1.566179382E+09 | 2.503384417E+09 | −6.932172042E+08 | −1.216091149E+06 |
| A22= | 6.193613868E+09 | −6.600880850E+09 | −9.147325025E+09 | 2.278449418E+09 | 1.786789711E+06 |
| A24= | −1.298524261E+10 | 1.722013368E+10 | 2.164170535E+10 | −4.990635896E+09 | −1.722521676E+06 |
| A26= | 1.616586573E+10 | −2.537997492E+10 | −2.981697597E+10 | 6.543026838E+09 | 9.775787429E+05 |
| A28= | −9.064546001E+09 | 1.613232907E+10 | 1.811501530E+10 | −3.882528747E+09 | −2.470507713E+05 |
| | Surface # | | | | |
| | 9 | 10 | 11 | 12 | 13 |
| k= | 9.000000000E+01 | −5.941690000E+00 | −1.670830000E−01 | −2.436560000E−02 | −6.695980000E+01 |
| A4= | −1.297870487E+00 | −2.714511081E−01 | 1.226939096E−01 | −1.770431960E+00 | −8.444868375E−01 |
| A6= | 5.600137210E+00 | −1.059006271E+00 | −3.098298869E+00 | 5.439813807E+00 | 2.345464909E+00 |
| A8= | −1.700557528E+01 | 1.501174600E+01 | 2.326911489E+01 | −7.192316419E+00 | −4.311447363E+00 |
| A10= | −1.008392279E+02 | −7.799931257E+01 | −9.369638664E+01 | 7.597515742E−02 | 5.921422872E+00 |
| A12= | 1.598734450E+03 | 2.214737376E+02 | 2.260114566E+02 | 1.673195281E+01 | −6.398171770E+00 |
| A14= | −9.706646344E+03 | −4.112152317E+02 | −3.596850295E+02 | −3.138519822E+01 | 5.378477950E+00 |
| A16= | 3.544765754E+04 | 5.326958366E+02 | 4.000707282E+02 | 3.224810853E+01 | −3.426154937E+00 |
| A18= | −8.458619976E+04 | −4.848732384E+02 | −3.207502259E+02 | −2.169945423E+01 | 1.624570526E+00 |
| A20= | 1.346107950E+05 | 3.030951291E+02 | 1.874988222E+02 | 1.007877981E+01 | −5.674246545E−01 |
| A22= | −1.416661723E+05 | −1.233839876E+02 | −7.946530709E+01 | −3.270223689E+00 | 1.442418295E−01 |
| A24= | 9.473924717E+04 | 2.877713137E+01 | 2.381618431E+01 | 7.303842745E−01 | −2.605577308E−02 |
| A26= | −3.649327100E+04 | −2.183726256E+00 | −4.785769438E+00 | −1.072409549E−01 | 3.182005505E−03 |
| A28= | 6.169192840E+03 | −4.908289328E−01 | 5.778587617E−01 | 9.330881875E−03 | −2.361751528E−04 |
| A30= | | 9.129632549E−02 | −3.164029207E−02 | −3.647991988E−04 | 8.054122189E−06 |

In the 8th embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 8th embodiment, so an explanation in this regard will not be provided again.

Moreover, these parameters can be calculated from Table 8A and Table 8B as the following values and satisfy the following conditions:

TABLE 8C
8th Embodiment

| | | | |
|---|---|---|---|
| f [mm] | 2.33 | \|R10/R1\| | 1.93 |
| Fno | 2.43 | R10/R2 | 0.95 |
| HFOV [deg.] | 46.9 | ATmax/ATmin | 4.36 |
| FOV [deg.] | 93.8 | CTmax/CTmin | 1.79 |
| TL/ImgH | 1.00 | ΣCT/ΣAT | 0.82 |
| tan(HFOV) | 1.07 | TD/CT5 | 13.34 |
| TD/EPD | 2.23 | T34/CT2 | 1.95 |
| TL/BL | 5.87 | T45/T34 | 1.78 |
| TL/f5 | −1.41 | CT3/ET3 | 1.48 |
| TL/CT4 | 13.47 | tan(CRA) | 0.87 |
| f1/f5 | −1.43 | Vmin | 16.3 |
| f/f12 | 0.78 | V1/V2 | 3.44 |
| \|f/f3\| + \|f/f4\| | 0.74 | V2/V3 | 0.44 |
| \|f/R2\| − \|f/R4\| | 1.17 | SAG5R2/CT5 | −2.66 |
| R2/TD | 0.77 | 10 × SAG1R1/R1 | 2.09 |
| R7/f45 | −0.17 | SAG4R1/ET4 | −1.00 |
| \|R2/R1\| | 2.03 | Y5R1/Y2R1 | 4.19 |
| \|R9/R1\| | 3.00 | Y1R1/ImgH | 0.19 |

### 9th Embodiment

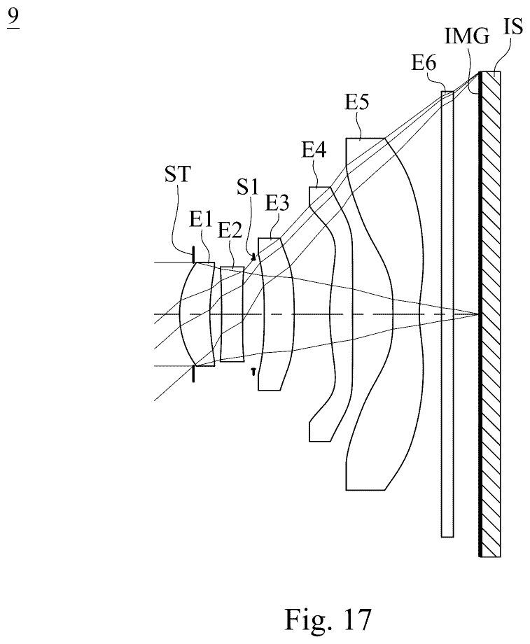

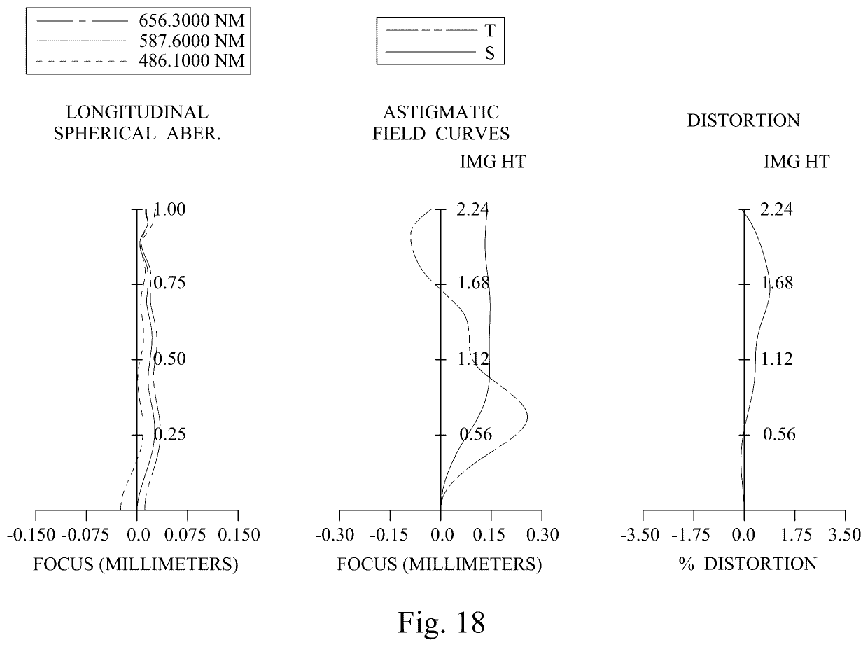

FIG. 17 is a schematic view of an imaging apparatus 9 according to the 9th embodiment of the present disclosure. FIG. 18 shows, in order from left to right, spherical aberration curves, astigmatic field curves and a distortion curve of the imaging apparatus according to the 9th embodiment. In FIG. 17, the imaging apparatus 9 according to the 9th embodiment includes an optical lens assembly (its reference number is omitted) and an image sensor IS. The optical lens assembly includes, in order from an object side to an image side along an optical path, an aperture stop ST, a first lens element E1, a second lens element E2, a stop S1, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points and one critical point.

The third lens element E3 with positive refractive power has an object-side surface being concave in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes two inflection points, the image-side surface of the third lens element E3 includes one inflection point.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points and one critical point, the image-side surface of the fourth lens element E4 includes four inflection points and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes one inflection point, the image-side surface of the fifth lens element E5 includes two inflection points and one critical point.

The filter E6 is made of glass material and disposed between the fifth lens element E5 and the image surface IMG and will not affect a focal length of the optical lens assembly.

The detailed optical data of the 9th embodiment are shown in Table 9A and the aspheric surface data are shown in Table 9B below.

TABLE 9A
9th Embodiment
f = 2.50 mm, Fno = 2.62, HFOV = 41.7 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.129 | | | | |
| 2 | Lens 1 | 0.8326 | ASP | 0.280 | Plastic | 1.544 | 56.0 | 2.62 |
| 3 | | 1.7618 | ASP | 0.108 | | | | |
| 4 | Lens 2 | 123.2098 | ASP | 0.194 | Plastic | 1.697 | 16.3 | −31.63 |
| 5 | | 18.6915 | ASP | 0.101 | | | | |
| 6 | Stop | Plano | | 0.099 | | | | |
| 7 | Lens 3 | −8.2096 | ASP | 0.277 | Plastic | 1.535 | 55.9 | 48.50 |
| 8 | | −6.3083 | ASP | 0.328 | | | | |
| 9 | Lens 4 | 1.6461 | ASP | 0.211 | Plastic | 1.544 | 56.0 | 3.80 |
| 10 | | 7.7195 | ASP | 0.373 | | | | |
| 11 | Lens 5 | −9.7667 | ASP | 0.244 | Plastic | 1.515 | 56.4 | −1.82 |
| 12 | | 1.0487 | ASP | 0.205 | | | | |

| | | | | | | | |
|---|---|---|---|---|---|---|---|
| 13 | Filter | Plano | 0.110 | Glass | 1.517 | 64.2 | — |
| 14 | | Plano | 0.249 | | | | |
| 15 | Image | Plano | — | | | | |

Reference wavelength is 587.6 nm (d-line).
Effective radius of Surface 6 (Stop S1) is 0.507 mm.

TABLE 9B
Aspheric Coefficients

| | Surface # | | | | |
|---|---|---|---|---|---|
| | 2 | 3 | 4 | 5 | 7 |
| k= | −1.581210000E−01 | 1.548440000E+00 | 1.064010000E+04 | 5.699130000E+01 | 3.511020000E+01 |
| A4= | 2.502320378E−01 | −3.892450704E+00 | −3.116837752E+00 | 2.417591672E+00 | 4.926706934E−01 |
| A6= | 4.828007589E+00 | 2.767123181E+02 | 1.936244853E+02 | −1.898984832E+02 | −5.429969773E+01 |
| A8= | −7.086210889E+02 | −1.197302457E+04 | −8.014764507E+03 | 8.024780281E+03 | 1.443619455E+03 |
| A10= | 2.738666025E+04 | 3.274075585E+05 | 2.122134761E+05 | −2.129479710E+05 | −2.353397387E+04 |
| A12= | −5.693916588E+05 | −5.994924471E+06 | −3.778697864E+06 | 3.795143286E+06 | 2.542028287E+05 |
| A14= | 7.375902863E+06 | 7.605447743E+07 | 4.676332752E+07 | −4.703390390E+07 | −1.882249737E+06 |
| A16= | −6.293708947E+07 | −6.810630928E+08 | −4.095070594E+08 | 4.131300070E+08 | 9.695832899E+06 |
| A18= | 3.601914232E+08 | 4.329863293E+09 | 2.551125954E+09 | −2.587317044E+09 | −3.468106907E+07 |
| A20= | −1.370045102E+09 | −1.940087613E+10 | −1.122018516E+10 | 1.147023461E+10 | 8.440822788E+07 |
| A22= | 3.323630516E+09 | 5.981976601E+10 | 3.400459349E+10 | −3.514592878E+10 | −1.332350806E+08 |
| A24= | −4.653830409E+09 | −1.206604651E+11 | −6.748821565E+10 | 7.075734253E+10 | 1.228990837E+08 |
| A26= | 2.861367086E+09 | 1.431796099E+11 | 7.885686905E+10 | −8.416982531E+10 | −5.025318178E+07 |
| A28= | | −7.570548472E+10 | −4.107525205E+10 | 4.480912961E+10 | |
| | Surface # | | | | |
| | 8 | 9 | 10 | 11 | 12 |
| k= | −5.931920000E+00 | −2.132250000E+01 | 1.014600000E+01 | −8.852220000E+00 | −1.671280000E+01 |
| A4= | −9.157073612E−01 | −5.058354811E−01 | −1.070396979E+00 | −3.136690764E+00 | −1.364500021E+00 |
| A6= | 1.913925157E+00 | 5.137973133E+00 | 8.724051627E+00 | 1.369373429E+01 | 5.258950581E+00 |
| A8= | 9.242633458E+00 | −3.704715399E+01 | −5.077659573E+01 | −4.367423398E+01 | −1.429960522E+01 |
| A10= | −2.663778453E+02 | 1.754777332E+02 | 2.199313714E+02 | 1.046521945E+02 | 2.791229188E+01 |
| A12= | 2.578828050E+03 | −5.837097443E+02 | −6.814321585E+02 | −1.786518647E+02 | −3.948495479E+01 |
| A14= | −1.480584153E+04 | 1.374613682E+03 | 1.483116815E+03 | 2.159108436E+02 | 4.077829159E+01 |
| A16= | 5.581163206E+04 | −2.374795370E+03 | −2.294960230E+03 | −1.870504593E+02 | −3.088840577E+01 |
| A18= | −1.413967373E+05 | 3.068959040E+03 | 2.560264811E+03 | 1.174265289E+02 | 1.716818733E+01 |
| A20= | 2.387590746E+05 | −2.936181474E+03 | −2.069551594E+03 | −5.353582286E+01 | −6.963371282E+00 |
| A22= | −2.580753040E+05 | 2.014651401E+03 | 1.202927835E+03 | 1.755458946E+01 | 2.031506297E+00 |
| A24= | 1.617117650E+05 | −9.448381691E+02 | −4.906130819E+02 | −4.034061414E+00 | −4.143014617E−01 |
| A26= | −4.470571275E+04 | 2.811687505E+02 | 1.333563372E+02 | 6.164987092E−01 | 5.597252616E−02 |
| A28= | | −4.626053332E+01 | −2.170075210E+01 | −5.625485507E−02 | −4.495218858E−03 |
| A30= | | 2.988302771E+00 | 1.599169621E+00 | 2.318221368E−03 | 1.622962444E−04 |

In the 9th embodiment, the equation of the aspheric surface profiles of the aforementioned lens elements is the same as the equation of the 1 st embodiment. Also, the definitions of these parameters shown in the following table are the same as those stated in the 1 st embodiment with corresponding values for the 9th embodiment, so an explanation in this regard will not be provided again.

Moreover, these parameters can be calculated from Table 9A and Table 9B as the following values and satisfy the following conditions:

TABLE 9C
9th Embodiment

| | | | |
|---|---|---|---|
| f [mm] | 2.50 | \|R10/R1\| | 1.26 |
| Fno | 2.62 | R10/R2 | 0.60 |
| HFOV [deg.] | 41.7 | ATmax/ATmin | 3.45 |
| FOV [deg.] | 83.4 | CTmax/CTmin | 1.44 |
| TL/ImgH | 1.24 | ΣCT/ΣAT | 1.20 |
| tan(HFOV) | 0.89 | TD/CT5 | 9.08 |
| TD/EPD | 2.32 | T34/CT2 | 1.69 |
| TL/BL | 4.93 | T45/T34 | 1.14 |
| TL/f5 | −1.52 | CT3/ET3 | 1.37 |
| TL/CT4 | 13.17 | tan(CRA) | 0.82 |
| f1/f5 | −1.44 | Vmin | 16.3 |
| f/f12 | 0.89 | V1/V2 | 3.44 |
| \|f/f3\| + \|f/f4\| | 0.71 | V2/V3 | 0.29 |
| \|f/R2\| − \|f/R4\| | 1.29 | SAG5R2/CT5 | −1.31 |
| R2/TD | 0.80 | 10 × SAG1R1/R1 | 2.01 |
| R7/f45 | −0.31 | SAG4R1/ET4 | −0.97 |
| \|R2/R1\| | 2.12 | Y5R1/Y2R1 | 3.22 |
| \|R9/R1\| | 11.73 | Y1R1/ImgH | 0.22 |

### 10th Embodiment

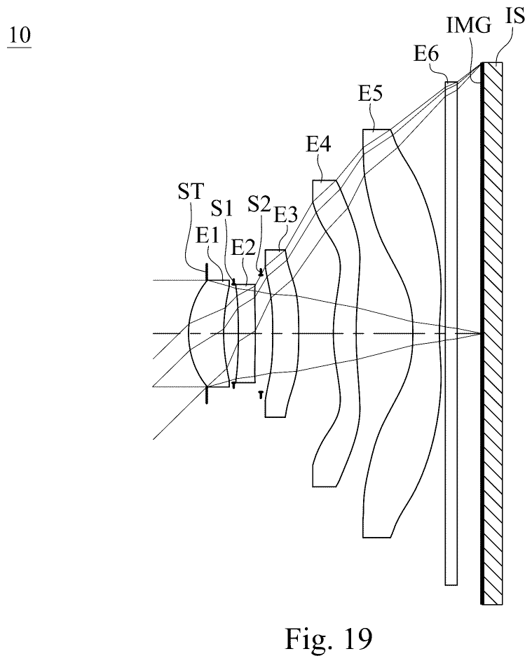

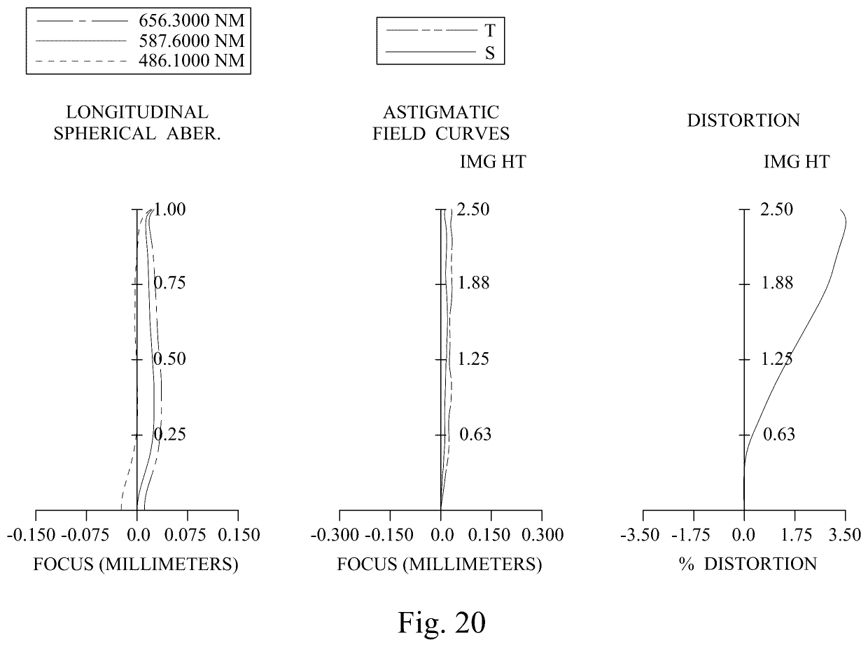

FIG. 19 is a schematic view of an imaging apparatus 10 according to the 10th embodiment of the present disclosure. FIG. 20 shows, in order from left to right, spherical aberration curves, astigmatic field curves and a distortion curve of the imaging apparatus according to the 10th embodiment. In FIG. 19, the imaging apparatus 10 according to the 10th embodiment includes an optical lens assembly (its reference number is omitted) and an image sensor IS. The optical lens assembly includes, in order from an object side to an image side along an optical path, an aperture stop ST, a first lens element E1, a stop S1, a second lens element E2, a stop S2, a third lens element E3, a fourth lens element E4, a fifth lens element E5, the filter E6 and an image surface IMG, wherein the image sensor IS is disposed on the image surface IMG of the optical lens assembly. The optical lens assembly includes five lens elements (E1, E2, E3, E4, E5) without additional one or more lens elements inserted between the first lens element E1 and the fifth lens element E5, and there is an air gap on an optical axis between each of adjacent lens elements of the five lens elements.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric. Moreover, the image-side surface of the first lens element E1 includes one inflection point.

The second lens element E2 with negative refractive power has an object-side surface being concave in a paraxial region thereof and an image-side surface being convex in a paraxial region thereof. The second lens element E2 is made of plastic material, and has the object-side surface and the image-side surface being both aspheric. Moreover, the image-side surface of the second lens element E2 includes one inflection point and one critical point.

The third lens element E3 with negative refractive power has an object-side surface being concave in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point, the image-side surface of the third lens element E3 includes two inflection points.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points and one critical point, the image-side surface of the fourth lens element E4 includes one inflection point and one critical point.

The fifth lens element E5 with negative refractive power has an object-side surface being concave in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes three inflection points and one critical point.

The filter E6 is made of glass material and disposed between the fifth lens element E5 and the image surface IMG and will not affect a focal length of the optical lens assembly.

The detailed optical data of the 10th embodiment are shown in Table 10A and the aspheric surface data are shown in Table 10B below.

TABLE 10A
10th Embodiment
f = 2.45 mm, Fno = 2.48, HFOV = 44.5 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Ape. Stop | Plano | | −0.168 | | | | |
| 2 | Lens 1 | 0.8092 | ASP | 0.324 | Plastic | 1.545 | 56.1 | 2.44 |
| 3 | | 1.7720 | ASP | 0.093 | | | | |
| 4 | Stop | Plano | | 0.043 | | | | |
| 5 | Lens 2 | −6.4938 | ASP | 0.156 | Plastic | 1.669 | 19.5 | −21.93 |
| 6 | | −11.7628 | ASP | 0.051 | | | | |
| 7 | Stop | Plano | | 0.110 | | | | |
| 8 | Lens 3 | −7.2653 | ASP | 0.240 | Plastic | 1.544 | 56.0 | −221.60 |
| 9 | | −7.8212 | ASP | 0.319 | | | | |
| 10 | Lens 4 | 1.4348 | ASP | 0.211 | Plastic | 1.544 | 56.0 | 4.37 |
| 11 | | 3.4340 | ASP | 0.523 | | | | |
| 12 | Lens 5 | −2.3607 | ASP | 0.245 | Plastic | 1.534 | 55.9 | −1.89 |
| 13 | | 1.8182 | ASP | 0.055 | | | | |

| | | | | | | | |
|---|---|---|---|---|---|---|---|
| 14 | Filter | Plano | 0.110 | Glass | 1.517 | 64.2 | — |
| 15 | | Plano | 0.231 | | | | |
| 16 | Image | Plano | — | | | | |

Reference wavelength is 587.6 nm (d-line).
Effective radius of Surface 4 (Stop S1) is 0.455 mm.
Effective radius of Surface 7 (Stop S2) is 0.540 mm.

TABLE 10B
Aspheric Coefficients

| | Surface # | | | | |
|---|---|---|---|---|---|
| | 2 | 3 | 5 | 6 | 8 |
| k= | −1.260080000E−01 | 4.007140000E+00 | −1.000000000E+00 | −1.000000000E+00 | −1.533170000E+01 |
| A4= | −1.313224228E−01 | −8.442664318E−02 | −5.166292537E−01 | −4.838431649E−01 | −1.363708326E+00 |
| A6= | 1.242613896E+01 | 3.237802691E+00 | 1.881258731E+01 | 1.861947328E+01 | 2.014387243E+01 |
| A8= | −4.439439650E+02 | −2.818222569E+02 | −9.310148283E+02 | −6.997324667E+02 | −4.417759896E+02 |
| A10= | 1.085871876E+04 | 1.180852037E+04 | 2.970748656E+04 | 1.932566320E+04 | 7.134003013E+03 |
| A12= | −1.833264918E+05 | −3.074785771E+05 | −6.295081548E+05 | −3.675921733E+05 | −8.039032599E+04 |
| A14= | 2.178786510E+06 | 5.292803310E+06 | 9.162835181E+06 | 4.916080031E+06 | 6.422908289E+05 |
| A16= | −1.843604879E+07 | −6.230667491E+07 | −9.337931448E+07 | −4.677157896E+07 | −3.677733716E+06 |
| A18= | 1.113568602E+08 | 5.092374160E+08 | 6.701975305E+08 | 3.176357646E+08 | 1.513424691E+07 |
| A20= | −4.761296048E+08 | −2.886799544E+09 | −3.361412816E+09 | −1.527629472E+09 | −4.434563212E+07 |
| A22= | 1.407124911E+09 | 1.112999471E+10 | 1.149014501E+10 | 5.079918923E+09 | 9.015750038E+07 |
| A24= | −2.734624188E+09 | −2.782543447E+10 | −2.539744177E+10 | −1.110576436E+10 | −1.206863851E+08 |
| A26= | 3.146932211E+09 | 4.064492455E+10 | 3.254427239E+10 | 1.435799804E+10 | 9.553103408E+07 |
| A28= | −1.627038573E+09 | −2.630622308E+10 | −1.822081579E+10 | −8.315864593E+09 | −3.384070459E+07 |
| | Surface # | | | | |
| | 9 | 10 | 11 | 12 | 13 |
| k= | 2.861970000E+01 | −7.854950000E+00 | 5.783500000E−01 | 0.000000000E+00 | −4.201070000E+01 |
| A4= | −1.184374561E+00 | −4.777387312E−01 | −4.505164533E−01 | −1.788930356E+00 | −1.066747226E+00 |
| A6= | 5.875086345E+00 | 1.750429136E+00 | 2.095607145E+00 | 7.133580793E+00 | 3.740401519E+00 |
| A8= | −4.302436449E+01 | −3.268321116E+00 | −5.378922845E+00 | −1.900215838E+01 | −9.083779134E+00 |
| A10= | 2.785078594E+02 | −1.734736881E+01 | 3.992941768E+00 | 3.729243149E+01 | 1.575096728E+01 |
| A12= | −1.499733451E+03 | 1.235650380E+02 | 1.075355116E+01 | −5.242085817E+01 | −1.986027840E+01 |
| A14= | 7.018891083E+03 | −3.938545978E+02 | −3.831618219E+01 | 5.281969869E+01 | 1.841721457E+01 |
| A16= | −2.739689855E+04 | 7.813540157E+02 | 6.383386157E+01 | −3.859049696E+01 | −1.263787520E+01 |
| A18= | 8.326331634E+04 | −1.034297517E+03 | −6.943869946E+01 | 2.059993727E+01 | 6.419623102E+00 |
| A20= | −1.840717108E+05 | 9.376650841E+02 | 5.257335776E+01 | −8.025809202E+00 | −2.398168678E+00 |
| A22= | 2.788729643E+05 | −5.854772116E+02 | −2.789049874E+01 | 2.254253952E+00 | 6.484202946E−01 |
| A24= | −2.711969553E+05 | 2.481220989E+02 | 1.015562992E+01 | −4.439050493E−01 | −1.231245385E−01 |
| A26= | 1.517559601E+05 | −6.830350891E+01 | −2.414850680E+00 | 5.806953555E−02 | 1.553832364E−02 |
| A28= | −3.708049082E+04 | 1.103697134E+01 | 3.373712490E−01 | −4.525702652E−03 | −1.168256337E−03 |
| A30= | | −7.957043949E−01 | −2.098554885E−02 | 1.587882187E−04 | 3.954669095E−05 |

In the 10th embodiment, the equation of the aspheric surface profiles of PG 49T the aforementioned lens elements is the same as the equation of the 1 st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 10A and Table 10B as the following values and satisfy the following conditions:

TABLE 10C
10th Embodiment

| | | | |
|---|---|---|---|
| f [mm] | 2.45 | \|R10/R1\| | 2.25 |
| Fno | 2.48 | R10/R2 | 1.03 |
| HFOV [deg.] | 44.5 | ATmax/ATmin | 3.85 |
| FOV [deg.] | 89.0 | CTmax/CTmin | 2.08 |
| TL/ImgH | 1.08 | ΣCT/ΣAT | 1.03 |
| tan(HFOV) | 0.98 | TD/CT5 | 9.45 |
| TD/EPD | 2.35 | T34/CT2 | 2.04 |
| TL/BL | 6.85 | T45/T34 | 1.64 |
| TL/f5 | −1.44 | CT3/ET3 | 1.30 |
| TL/CT4 | 12.85 | tan(CRA) | 0.86 |
| f1/f5 | −1.30 | Vmin | 19.5 |
| f/f12 | 0.91 | V1/V2 | 2.88 |
| \|f/f3\| + \|f/f4\| | 0.57 | V2/V3 | 0.35 |
| \|f/R2\| −\|f/R4\| | 1.17 | SAG5R2/CT5 | −1.84 |
| R2/TD | 0.77 | 10 × SAG1R1/R1 | 2.17 |
| R7/f45 | −0.29 | SAG4R1/ET4 | −0.88 |
| \|R2/R1\| | 2.19 | Y5R1/Y2R1 | 4.04 |
| \|R9/R1\| | 2.92 | Y1R1/ImgH | 0.20 |

### 11th Embodiment

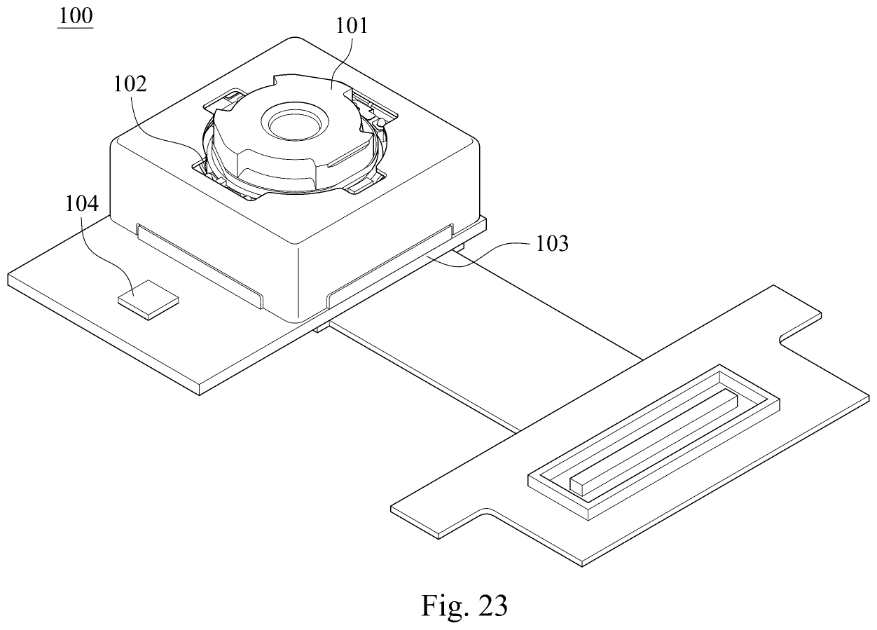

FIG. 23 is a three-dimensional schematic view of an imaging apparatus 100 according to the 11th embodiment of the present disclosure. In FIG. 23, the imaging apparatus 100 of the 11th embodiment is a camera module, the imaging apparatus 100 includes an imaging lens assembly 101, a driving apparatus 102 and an image sensor 103, wherein the imaging lens assembly 101 includes the optical lens assembly of the present disclosure and a lens barrel (its reference number is omitted) for carrying the optical lens assembly. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can be an auto-focus module, which can be driven by driving systems, such as voice coil motors (VCM), micro electro-mechanical systems (MEMS), piezoelectric systems, and shape memory alloys etc. The optical lens assembly can obtain a favorable imaging position by the driving apparatus 102 to capture clear images when the imaged object is disposed at different object distances.

The imaging apparatus 100 can include the image sensor 103 located on the image surface of the optical lens assembly, such as CMOS and CCD, with superior photosensitivity and low noise. Thus, it is favorable for providing realistic images with high definition image quality thereof. Moreover, the imaging apparatus 100 can further include an image stabilization module 104, which can be a kinetic energy sensor, such as an accelerometer, a gyro sensor, and a Hall Effect sensor. In the 11th embodiment, the image stabilization module 104 is a gyro sensor, but is not limited thereto. Therefore, the variation of different axial directions of the optical lens assembly can adjusted to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

### 12th Embodiment

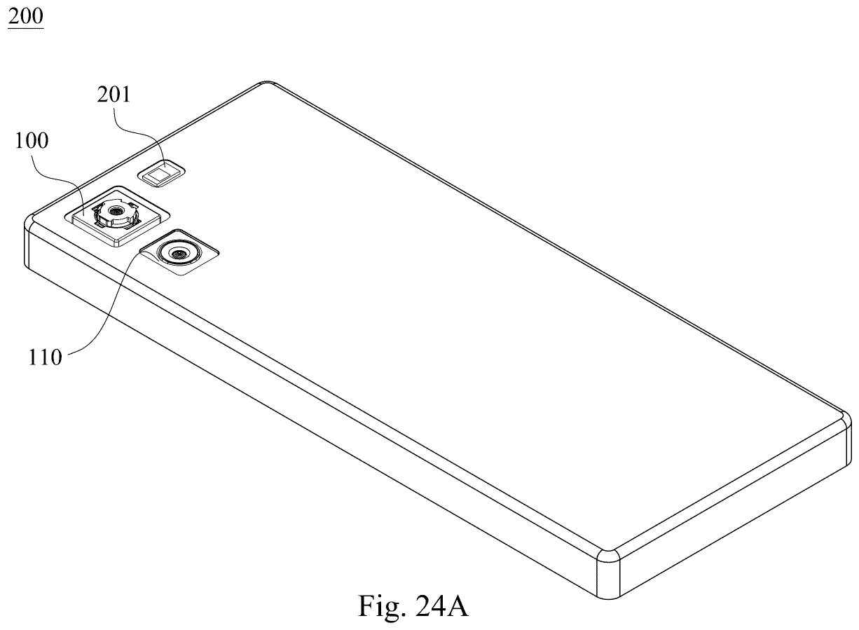

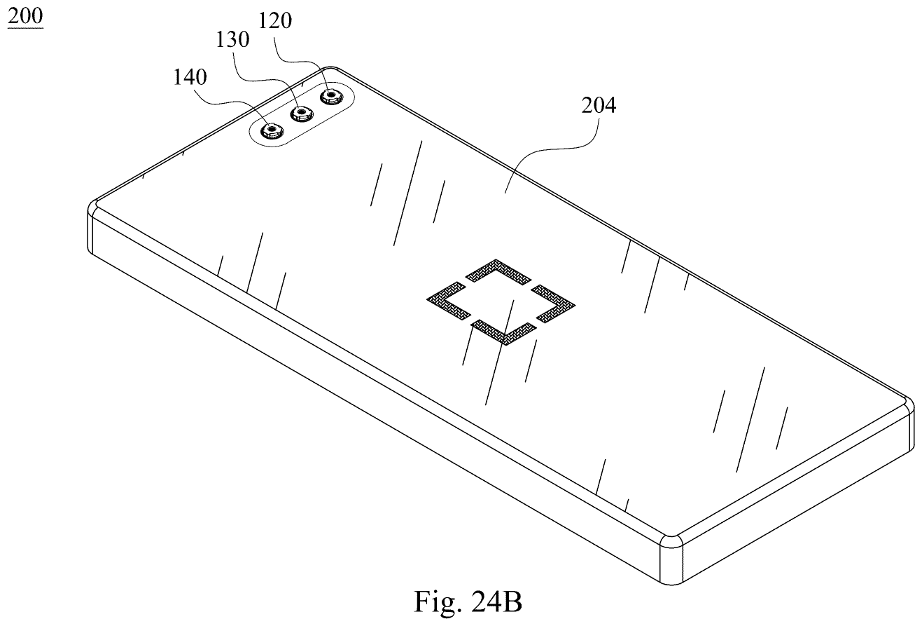

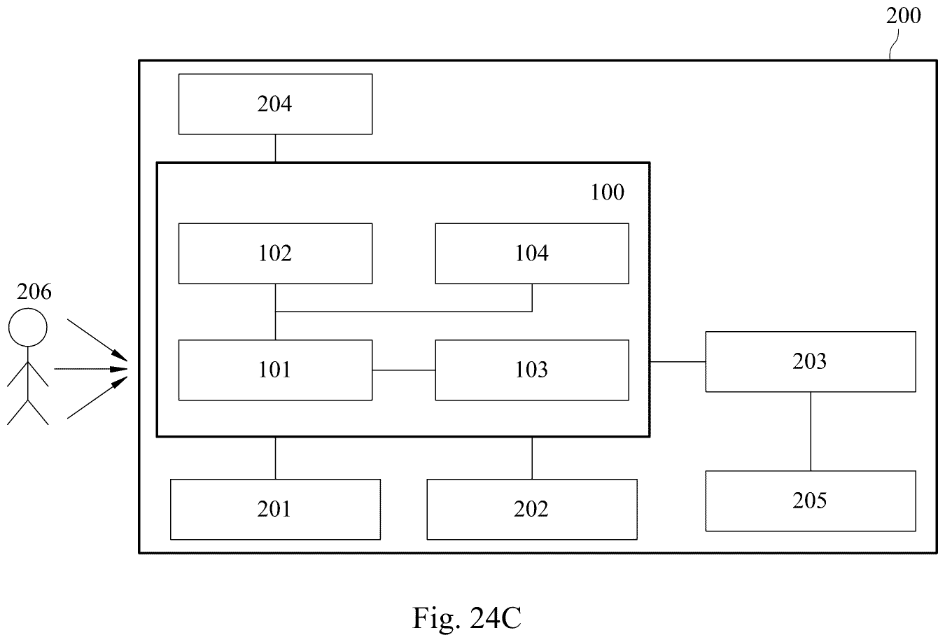

FIG. 24A is a schematic view of one side of an electronic device 200 according to the 12th embodiment of the present disclosure. FIG. 24B is a schematic view of another side of the electronic device 200 of FIG. 24A. FIG. 24C is a system schematic view of the electronic device 200 of FIG. 24A. In FIG. 24A, FIG. 24B and FIG. 24C, the electronic device 200 according to the 12th embodiment is a smartphone, which include imaging apparatuses 100, 110, 120, 130, 140, a flash module 201, a focusing assisting module 202, an image signal processor (ISP) 203, a user interface 204 and an image software processor 205, wherein each of the imaging apparatuses 120, 130, 140 is a front camera. When the user captures images of an imaged object 206 via the user interface 204, the electronic device 200 focuses and generates an image via at least one of the imaging apparatuses 100, 110, 120, 130, 140, while compensating for low illumination via the flash module 201 when necessary. Then, the electronic device 200 quickly focuses on the imaged object 206 according to its object distance information provided by the focusing assisting module 202, and optimizes the image via the image signal processor 203 and the image software processor 205. Thus, the image quality can be further enhanced. The focusing assisting module 202 can adopt conventional infrared or laser for obtaining quick focusing, and the user interface 204 can utilize a touch screen or a physical button for capturing and processing the image with various functions of the image processing software.

Each of the imaging apparatuses 100, 110, 120, 130, 140 according to the 12th embodiment can include the optical lens assembly of the present disclosure, and can be the same or similar to the imaging apparatus 100 according to the aforementioned 11th embodiment, and will not describe again herein. In detail, according to the 12th embodiment, the imaging apparatuses 100, 110 can be wide angle imaging apparatus and ultra-wide angle imaging apparatus, respectively. The imaging apparatuses 100, 110 can also be wide angle imaging apparatus and telephoto imaging apparatus, respectively. The imaging apparatuses 120, 130, 140 can be wide angle imaging apparatus, ultra-wide angle imaging apparatus and TOF (Time-Of-Flight) module, respectively, or can be others imaging apparatuses, which will not be limited thereto. Further, the connecting relationships between each of the imaging apparatuses 110, 120, 130, 140 and other elements can be the same as the imaging apparatus 100 in FIG. 24C, or can be adaptively adjusted according to the type of the imaging apparatuses, which will not be shown and detailed descripted again.

### 13th Embodiment

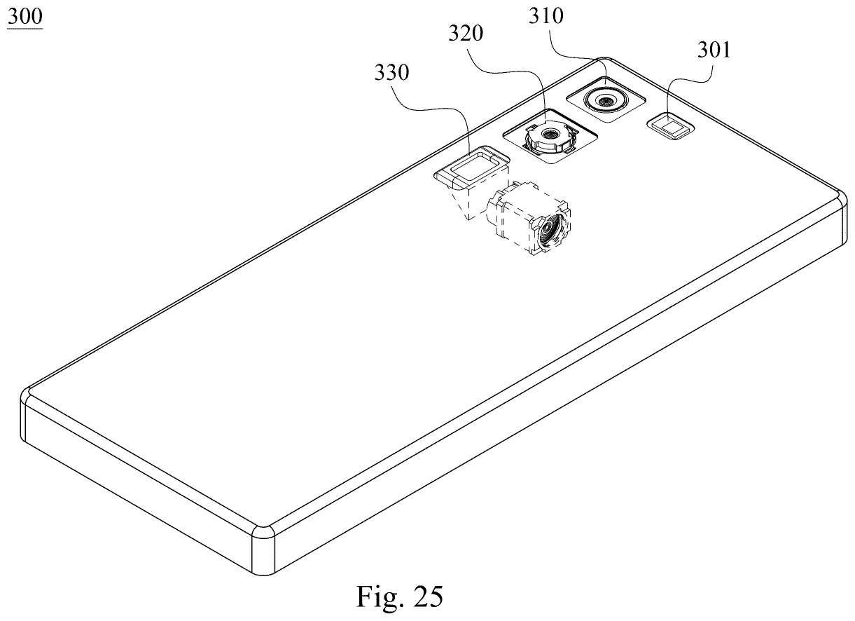

FIG. 25 is a schematic view of one side of an electronic device 300 according to the 13th embodiment of the present disclosure. According to the 13th embodiment, the electronic device 300 is a smartphone, which include imaging apparatuses 310, 320, 330 and a flash module 301.

The electronic device 300 according to the 13th embodiment can include the same or similar elements to that according to the 12th embodiment, and each of the imaging apparatuses 310, 320, 330 according to the 13th embodiment can have a configuration which is the same or similar to that according to the 12th embodiment, and will not describe again herein. In detail, according to the 13th embodiment, each of the imaging apparatuses 310, 320, 330 can include the optical lens assembly of the present disclosure, and can be the same or similar to the imaging apparatus 100 according to the aforementioned 11th embodiment, and will not describe again herein. In detail, the imaging apparatus 310 can be ultra-wide angle imaging apparatus, the imaging apparatus 320 can be wide angle imaging apparatus, the imaging apparatus 330 can be telephoto imaging apparatus (which can include light path folding element), or can be adaptively adjusted according to the type of the imaging apparatuses, which will not be limited to the arrangement.

### 14th Embodiment

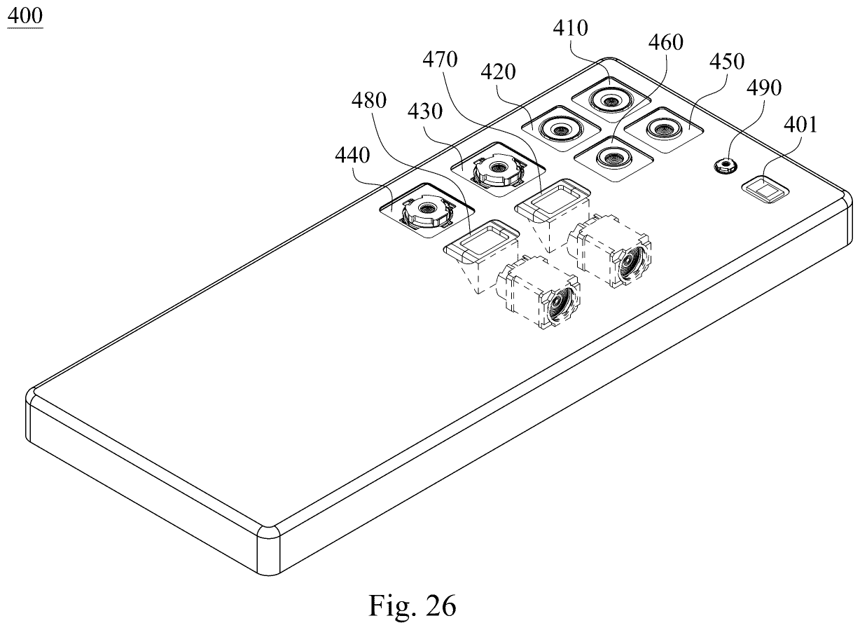

FIG. 26 is a schematic view of one side of an electronic device 400 according to the 14th embodiment of the present disclosure. According to the 14th embodiment, the electronic device 400 is a smartphone, which include imaging apparatuses 410, 420, 430, 440, 450, 460, 470, 480, 490 and a flash module 401.

The electronic device 400 according to the 14th embodiment can include the same or similar elements to that according to the 12th embodiment, and each of the imaging apparatuses 410, 420, 430, 440, 450, 460, 470, 480, 490 and the flash module 401 can have a configuration which is the same or similar to that according to the 12th embodiment, and will not describe again herein. In detail, according to the 14th embodiment, each of the imaging apparatuses 410, 420, 430, 440, 450, 460, 470, 480, 490 can include the optical lens assembly of the present disclosure, and can be the same or similar to the imaging apparatus 100 according to the aforementioned 11th embodiment, and will not describe again herein.

In detail, each of the imaging apparatuses 410, 420 can be ultra-wide angle imaging apparatus, each of the imaging apparatuses 430, 440 can be wide angle imaging apparatus, each of the imaging apparatuses 450, 460 can be telephoto imaging apparatus, each of the imaging apparatuses 470, 480 can be telephoto imaging apparatus (which can include light path folding element), the imaging apparatus 490 can be TOF module, or can be adaptively adjusted according to the type of the imaging apparatuses, which will not be limited to the arrangement.

### 15th Embodiment

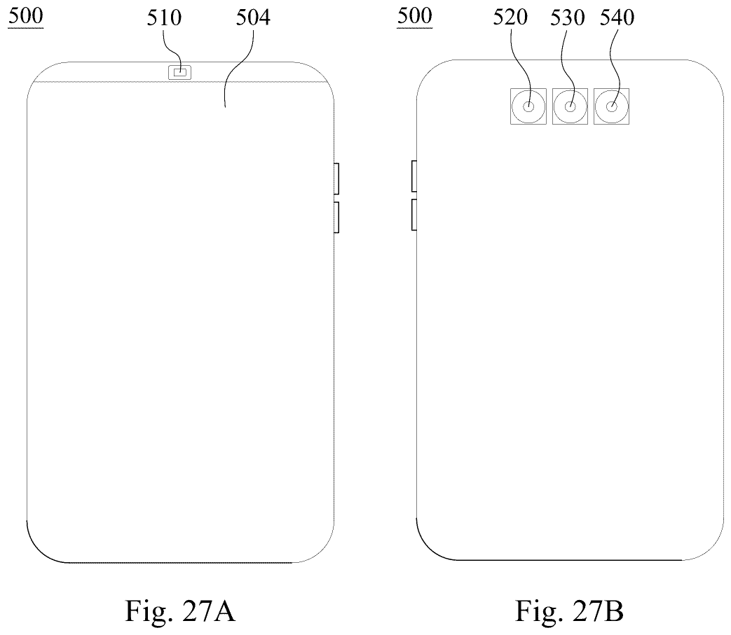

FIG. 27A is a schematic view of one side of an electronic device 500 according to the 15th embodiment of the present disclosure. FIG. 27B is a schematic view of another side of the electronic device 500 of FIG. 27A. In FIG. 27A and FIG. 27B, according to the 15th embodiment, the electronic device 500 is a smartphone, which include imaging apparatuses 510, 520, 530, 540 and a user interface 504.

The electronic device 500 according to the 15th embodiment can include the same or similar elements to that according to the 12th embodiment, and each of the imaging apparatuses 510, 520, 530, 540 and the user interface 504 can have a configuration which is the same or similar to that according to the 12th embodiment, and will not describe again herein. In detail, according to the 15th embodiment, the imaging apparatus 510 corresponds to a non-circular opening located on an outer side of the electronic device 500 for capturing the image, and the imaging apparatuses 520, 530, 540 can be telephoto imaging apparatus, wide angle imaging apparatus and ultra-wide angle imaging apparatus, respectively, or can be adaptively adjusted according to the type of the imaging apparatuses, which will not be limited to the arrangement.

### 16th Embodiment

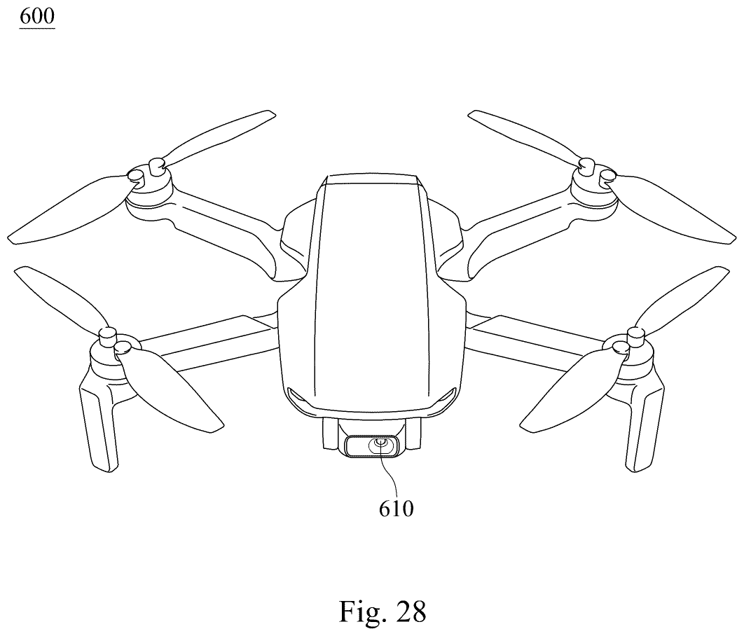

FIG. 28 is a three-dimensional schematic view of an electronic device 600 according to the 16th embodiment of the present disclosure. In FIG. 28, the electronic device 600 of the 16th embodiment is a drone, which includes an imaging apparatus 610. The imaging apparatus 610 can include the optical lens assembly of the present disclosure, and can be the same or similar to the imaging apparatus 100 according to the aforementioned 11th embodiment, and will not describe again herein.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical lens assembly comprising five lens elements, the five lens elements being, in order from an object side to an image side:
a first lens element, a second lens element, a third lens element, a fourth lens element and a fifth lens element; each of the five lens elements has an object-side surface towards the object side and an image-side surface towards the image side;
wherein the fourth lens element with positive refractive power has the object-side surface being convex in a paraxial region thereof;
the fifth lens element with negative refractive power has the object-side surface being concave in a paraxial region thereof and the image-side surface being concave in a paraxial region thereof;
wherein an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the first lens element is R1, a curvature radius of the object-side surface of the fourth lens element is R7, a curvature radius of the object-side surface of the fifth lens element is R9, an axial distance between the object-side surface of the first lens element and an image surface is TL, a central thickness of the fourth lens element is CT4, a composite focal length of the fourth lens element and the fifth lens element is f45, a sum of all central thicknesses of the five lens elements of the optical lens assembly is ΣCT, a sum of all axial distances between adjacent lens elements of the optical lens assembly is ΣAT, and the following conditions are satisfied:
2.0<ATmax/ATmin<7.5;
−1.50<R7/f45<0.00;
9.60<TL/CT4<18.00;
0.60<ΣCT/ΣAT<1.30; and
0.08<|R9/R1|<45.00.

2. The optical lens assembly of claim 1, wherein the first lens element has positive refractive power, the object-side surface of the first lens element is convex in a paraxial region thereof, the image-side surface of the first lens element is concave in a paraxial region thereof; the image-side surface of the fourth lens element comprises at least one inflection point.

3. The optical lens assembly of claim 1, wherein the axial distance between the object-side surface of the first lens element and the image surface is TL, a maximum image height of the optical lens assembly is ImgH, and the following condition is satisfied:
0.90<TL/ImgH<1.28.

4. The optical lens assembly of claim 1, wherein the object-side surface of the fifth lens element comprises at least one inflection point; a curvature radius of the image-side surface of the first lens element is R2, an axial distance between the object-side surface of the first lens element and the image-side surface of the fifth lens element is TD, and the following condition is satisfied:
0.2<R2/TD<1.5.

5. The optical lens assembly of claim 1, wherein a focal length of the optical lens assembly is f, a curvature radius of the image-side surface of the first lens element is R2, a curvature radius of the image-side surface of the second lens element is R4, a focal length of the first lens element is f1, a focal length of the fifth lens element is f5, and the following conditions are satisfied:
0.30<|f/R2|−|f/R4|<5.00; and
−2.50<f1/f5<−1.00.

6. The optical lens assembly of claim 1, wherein at least two of the five lens elements are made of plastic material, there is an air gap on an optical axis between each of adjacent lens elements of the five lens elements; an Abbe number of the first lens element is V1, an Abbe number of the second lens element is V2, an Abbe number of the third lens element is V3, an Abbe number of the fourth lens element is V4, an Abbe number of the fifth lens element is V5, a minimum among V1, V2, V3, V4, V5 is Vmin, and the following condition is satisfied:
10.0<Vmin<22.0.

7. The optical lens assembly of claim 1, wherein the axial distance between the third lens element and the fourth lens element is T34, a central thickness of the second lens element is CT2, an Abbe number of the first lens element is V1, an Abbe number of the second lens element is V2, and the following conditions are satisfied:
0.8<T34/CT2<4.0; and
2.50<V1/V2<4.00.

8. The optical lens assembly of claim 1, wherein an f-number of the optical lens assembly is Fno, and the following condition is satisfied:
1.80<Fno<2.65.

9. The optical lens assembly of claim 1, wherein an incident angle between a chief ray in a maximum field of view of the optical lens assembly and the image surface is CRA, a central thickness of the third lens element is CT3, a distance in parallel with an optical axis between a maximum effective radius position of the object-side surface of the third lens element and a maximum effective radius position of the image-side surface of the third lens element is ET3, and the following conditions are satisfied:
0.70<tan(CRA)<1.15; and
0.83<CT3/ET3<2.50.

10. The optical lens assembly of claim 1, wherein a maximum effective radius of the object-side surface of the second lens element is Y2R1, a maximum effective radius of the object-side surface of the fifth lens element is Y5R1, an axial distance between the object-side surface of the first lens element and the image-side surface of the fifth lens element is TD, an entrance pupil diameter of the optical lens assembly is EPD, and the following conditions are satisfied:
2.70<Y5R1/Y2R1<4.70; and
1.70<TD/EPD<2.60.

11. An imaging apparatus, comprising:
the optical lens assembly of claim 1; and
an image sensor disposed on the image surface of the optical lens assembly.

12. An electronic device, comprising:
the imaging apparatus of claim 11.

13. An optical lens assembly comprising five lens elements, the five lens elements being, in order from an object side to an image side:
a first lens element, a second lens element, a third lens element, a fourth lens element and a fifth lens element; each of the five lens elements has an object-side surface towards the object side and an image-side surface towards the image side;
wherein the image-side surface of the first lens element is concave in a paraxial region thereof;
the object-side surface of the fourth lens element is convex in a paraxial region thereof;
the object-side surface of the fifth lens element is concave in a paraxial region thereof, the image-side surface of the fifth lens element comprises at least one inflection point;
wherein an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the fourth lens element is R7, an axial distance between the object-side surface of the first lens element and an image surface is TL, a focal length of the optical lens assembly is f, a focal length of the third lens element is f3, a focal length of the fourth lens element is f4, a composite focal length of the fourth lens element and the fifth lens element is f45, a central thickness of the first lens element is CT1, a central thickness of the second lens element is CT2, a central thickness of the third lens element is CT3, a central thickness of the fourth lens element is CT4, a central thickness of the fifth lens element is CT5, a maximum among CT1, CT2, CT3, CT4, CT5 is CTmax, a minimum among CT1, CT2, CT3, CT4, CT5 is CTmin, and the following conditions are satisfied:
2.0<ATmax/ATmin<7.5;
−1.50<R7/f45<0.00;
9.60<TL/CT4<18.00;
0.03<|f/f3|+|f/f4|<1.60; and
1.40<CTmax/CTmin<2.80.

14. The optical lens assembly of claim 13, wherein the first lens element has positive refractive power, the object-side surface of the first lens element is convex in a paraxial region thereof; the fourth lens element has positive refractive power; the fifth lens element has negative refractive power, the image-side surface of the fifth lens element is concave in a paraxial region thereof, the image-side surface of the fifth lens element comprises at least one critical point.

15. The optical lens assembly of claim 13, wherein half of a maximum field of view of the optical lens assembly is HFOV, and the following condition is satisfied:
0.83<tan(HFOV)<1.30.

16. The optical lens assembly of claim 13, wherein the axial distance between the object-side surface of the first lens element and the image surface is TL, a focal length of the fifth lens element is f5, a curvature radius of the object-side surface of the first lens element is R1, a curvature radius of the image-side surface of the fifth lens element is R10, and the following conditions are satisfied:
−1.80<TL/f5<−0.90; and
1.00<|R10/R1|<3.80.

17. The optical lens assembly of claim 13, further comprising:
an aperture stop, disposed on an object side of the third lens element;
wherein a curvature radius of the image-side surface of the first lens element is R2, a curvature radius of the image-side surface of the fifth lens element is R10, and the following condition is satisfied:
0.4<R10/R2<8.5.

18. The optical lens assembly of claim 13, wherein the image-side surface of the fourth lens element comprises at least one critical point, at least one of the object-side surface and the image-side surface of each of at least three of the first lens element to the fifth lens element are aspheric; wherein a maximum effective radius of the object-side surface of the first lens element is Y1R1, a maximum image height of the optical lens assembly is ImgH, and the following condition is satisfied:
0.13<Y1R1/ImgH<0.25.

19. The optical lens assembly of claim 13, wherein a distance in parallel with an optical axis from an axial vertex on the image-side surface of the fifth lens element to a maximum effective radius position on the image-side surface of the fifth lens element is SAG5R2, the central thickness of the fifth lens element is CT5, and the following condition is satisfied:
−3.50<SAG5R2/CT5<−1.00.

20. An optical lens assembly comprising five lens elements, the five lens elements being, in order from an object side to an image side:
a first lens element, a second lens element, a third lens element, a fourth lens element and a fifth lens element; each of the five lens elements has an object-side surface towards the object side and an image-side surface towards the image side;
wherein the image-side surface of the first lens element is concave in a paraxial region thereof;
the object-side surface of the fourth lens element is convex in a paraxial region thereof, the object-side surface of the fourth lens element comprises at least one inflection point;
the fifth lens element with negative refractive power has the object-side surface being concave in a paraxial region thereof;
wherein an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, a maximum among T12, T23, T34, T45 is ATmax, a minimum among T12, T23, T34, T45 is ATmin, a curvature radius of the object-side surface of the first lens element is R1, a curvature radius of the image-side surface of the first lens element is R2, a curvature radius of the object-side surface of the fourth lens element is R7, a focal length of the optical lens assembly is f, a composite focal length of the first lens element and the second lens element is f12, a composite focal length of the fourth lens element and the fifth lens element is f45, a sum of all central thicknesses of the five lens elements of the optical lens assembly is ΣCT, a sum of all axial distances between adjacent lens elements of the optical lens assembly is ΣAT, and the following conditions are satisfied:
2.00<ATmax/ATmin<6.20;
−1.25<R7/f45<−0.03;
0.60<ICT/YΣAT<1.20;
0.60<f/f12<1.10; and
0.30<|R2/R1|<12.00.

21. The optical lens assembly of claim 20, wherein the first lens element has positive refractive power, the object-side surface of the first lens element is convex in a paraxial region thereof; the fourth lens element has positive refractive power, the object-side surface of the fourth lens element comprises at least one critical point; the image-side surface of the fifth lens element is concave in a paraxial region thereof.

22. The optical lens assembly of claim 20, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the maximum among T12, T23, T34, T45 is ATmax, an axial distance between the object-side surface of the first lens element and an image surface is TL, an axial distance between the image-side surface of the fifth lens element and the image surface is BL, and the following conditions are satisfied:
T45=ATmax; and
4.50<TL/BL<7.00.

23. The optical lens assembly of claim 20, wherein the axial distance between the third lens element and the fourth lens element is T34, the axial distance between the fourth lens element and the fifth lens element is T45, an axial distance between the object-side surface of the first lens element and an image surface is TL, a focal length of the fifth lens element is f5, and the following conditions are satisfied:
0.90<T45/T34<2.60; and
−1.80<TL/f5<−0.90.

24. The optical lens assembly of claim 20, wherein an axial distance between the object-side surface of the first lens element and the image-side surface of the fifth lens element is TD, a central thickness of the fifth lens element is CT5, an Abbe number of the second lens element is V2, an Abbe number of the third lens element is V3, and the following conditions are satisfied:
7.00<TD/CT5<15.00; and
0.20<V2/V3<0.48.

25. The optical lens assembly of claim 20, wherein a distance in parallel with an optical axis from an axial vertex on the object-side surface of the first lens element to a maximum effective radius position on the object-side surface of the first lens element is SAG1R1, a distance in parallel with the optical axis from an axial vertex on the object-side surface of the fourth lens element to a maximum effective radius position on the object-side surface of the fourth lens element is SAG4R1, a distance in parallel with the optical axis between the maximum effective radius position of the object-side surface of the fourth lens element and a maximum effective radius position of the image-side surface of the fourth lens element is ET4, the curvature radius of the object-side surface of the first lens element is R1, and the following conditions are satisfied:
−1.60<SAG4R1/ET4<−0.25; and
1.50<10×SAG1R1/R1<2.70.

26. The optical lens assembly of claim 20, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the maximum among T12, T23, T34, T45 is ATmax, the minimum among T12, T23, T34, T45 is ATmin, the curvature radius of the object-side surface of the first lens element is R1, the curvature radius of the image-side surface of the first lens element is R2, the curvature radius of the object-side surface of the fourth lens element is R7, a curvature radius of the object-side surface of the fifth lens element is R9, an axial distance between the object-side surface of the first lens element and an image surface is TL, the focal length of the optical lens assembly is f, a focal length of the third lens element is f3, a focal length of the fourth lens element is f4, the composite focal length of the first lens element and the second lens element is f12, the composite focal length of the fourth lens element and the fifth lens element is f45, a central thickness of the first lens element is CT1, a central thickness of the second lens element is CT2, a central thickness of the third lens element is CT3, a central thickness of the fourth lens element is CT4, a central thickness of the fifth lens element is CT5, a maximum among CT1, CT2, CT3, CT4, CT5 is CTmax, a minimum among CT1, CT2, CT3, CT4, CT5 is CTmin, the sum of all the central thicknesses of the five lens elements of the optical lens assembly is ΣCT, the sum of all the axial distances between the adjacent lens elements of the optical lens assembly is ΣAT, and the following conditions are satisfied:
3.34≤ATmax/ATmin<4.36;
−0.32≤R7/f45≤−0.15;
10.79≤TL/CT4≤13.57;
0.82≤ΣCT/YΣAT≤1.20;
1.49≤|R9/R1|≤11.73;
0.57≤|f/f3|+|f/f4|≤1.28;
1.44≤CTmax/CTmin≤2.54;
0.77≤f/f12≤1.00; and
2.01≤|R2/R1|≤2.54.
